(19) United States
(12) Patent Application Publication
(10) Pub. No.: US 2009/0204463 A1
(43) Pub. Date: Aug. 13, 2009

(54) METHOD, TOOL, AND SYSTEM FOR ANALYZING A PROJECT

(75) Inventors: Joseph P. Burnett, Endicott, NY (US); Richard G. Fairbrother, Vestal, NY (US)

Correspondence Address: MICHAEL BEST & FRIEDRICH LLP, 100 E WISCONSIN AVENUE, Suite 3300, MILWAUKEE, WI, 53202, US

(73) Assignee: LOCKHEED MARTIN CORPORATION, Bethesda, MD (US)

(21) Appl. No.: 12/369,872

(22) Filed: Feb. 12, 2009

Related U.S. Application Data
(60) Provisional application No. 61/028,239, filed on Feb. 13, 2008.

(51) Int. Cl. G06Q 10/00

(52) U.S. Cl. 705/8; 705/7

(57) ABSTRACT

A tool for performing project management analysis on a project. Also disclosed are a system and a method of analyzing the project. The tool includes a project manager implemented to receive project data relating to a schedule, a discrete event simulator to create a model of the project using the project data and to perform a simulation with the model, a database, and an interface to promote interaction between the project manager, the discrete event simulator, and the database.

### RELATED APPLICATION

The application claims priority to U.S. Provisional Patent Application Ser. No. 61/028,239 filed on Feb. 13, 2008, the entire content of which is incorporated herein by reference.

### FIELD OF THE INVENTION

The invention relates to methods, software, and systems for analyzing data from a simulation of a project. The invention also relates to methods, software, and systems for creating and performing the simulation.

### BACKGROUND

Project management analysis is often performed with customized software. However, one popular program having a well-known user interface is MS-Project® software from Microsoft Corporation.

Typical approaches of dynamically modeling the function and performance of systems are defined in a series of charts created using either MS-Visio® or MS-PowerPoint® software from Microsoft Corporation. When creating the model, the systems are manually configured within the simulation tool.

### SUMMARY

MS-Project® software or other commercially-available software may be used by an integrated product team (IPT) to define complex task routings and task configurations of numerous types of systems. Although each system defined by the MS-Project® schedule may share a subset of tasks, typically there is a disparity of the overall set of tasks and task routings between the systems. To replicate such definitions within a simulation tool requires a great deal of complex source code. In a dynamic environment where the IPT is making constant changes to the MS-Project® document, it is virtually impossible to make the necessary manual changes to the simulation and provide required analysis.

In one embodiment, the invention provides a tool, such as a tool incorporated in or with an interface, for extending the level of project management analysis of a project management software package, such as MS-Project® software, by leveraging the strengths of a discrete event simulation software package, such as the Arena® software available from Rockwell Corporation. Since a project or structure, including one or more systems, is already defined within the software-produced schedule, the solution loads the project configuration into an Arena® or other based simulation. When changes are made to the MS-Project® or other scheduling software by the IPT, the changes can be reflected within the Arena® or other based simulation without the need for complex, time consuming changes to the simulation source code. This results in a quicker turnaround of analysis of the project.

Additionally, utilizing a discrete event simulation package for project management analysis can provide an increased level of understanding of the relationships between the entities that are defined within the project management package. Such analysis includes, in one embodiment, individually or inclusive:
workspace analysis, including the space required for a sequence of tasks;
primary task and task performance, including the percentage of total task duration waiting for a resource or workspace;
impacts on a schedule as a results of variable headcount per staffing type, per shift;
comparison of the baseline schedule with the actual schedule (generated by the results of the simulation); and
dynamic animation graphics of the system's operation.

Another possible benefit to the solution, in some embodiments, is the capability to generate static analysis of a project, such as a schedule produced by MS-Project® or other scheduling software. As opposed to analyzing the relationships between the components that comprise the system, the static analysis focuses on analyzing characteristics of the individual components that comprise the system. This provides the capability to eliminate issues that may complicate the results of the dynamic simulation.

The method, software, and system reduce the tediously manual process of replicating the one or more systems that are defined by the project management software within the discrete event simulation tool. The method, software, and system also decrease the turnaround time between the moment changes are made to the schedule and increase the availability of the analysis of those changes.

Other aspects and embodiments of the invention will become apparent by consideration of the detailed description and accompanying drawings.

### BRIEF DESCRIPTION OF THE DRAWINGS

FIG. 1 is a block diagram representing a computer system incorporating the invention.

FIG. 2 is a block diagram representing software packages and interfaces executable by the computer system of FIG. 1.

FIG. 3 is a block diagram providing a more detailed representation of FIG. 2.

FIG. 4 is a screen print of a schedule being prepared using MS-Project® software.

FIG. 5 is a partial block diagram, partial flow chart representing the transfer of Schedule data to the Input Data Tables.

FIG. 6 is a partial block diagram, partial flow chart representing the interaction of some of the components of the system of FIG. 2.

FIG. 7 is a screen print of an add-in menu in a spreadsheet-generating program, here MS-Excel® software from Microsoft Corporation.

FIG. 8 is a partial block diagram, partial flow chart representing a Transfer Schedule to Database tool.

FIG. 9 is a partial block diagram, partial flow chart representing the processing of a dynamic analysis.

FIG. 10 is a partial block diagram, partial flow chart representing the Model Initialization module of the Discrete Event Simulation software package.

FIG. 11 is a partial block diagram, partial flow chart representing the Create System module of the Discrete Event Simulation software package.

FIG. 12 is a partial block diagram, partial flow chart representing the Task Routing module of the Discrete Event Simulation software package.

FIG. 13 is a partial block diagram, partial flow chart representing the Write Data module of the Discrete Event Simulation software package.

FIG. 14-16 comprise a partial block diagram, partial flow chart representing exemplary data flow among the components of the System of FIG. 1.

FIG. 17 is a partial block diagram, partial flow chart representing multiple tools for generating analyses.

FIG. 18 is a partial block diagram, partial flow chart representing the Format MS-Project® Schedule utility.

FIGS. 19-22 are screen prints of exemplary displays resulting from the Facility Workspace Analysis.

FIGS. 23-26 are screen prints of exemplary displays resulting from the System Workspace Analysis.

FIGS. 27-30 are screen prints of exemplary displays resulting from the Staffing Analysis.

FIGS. 31-34 are screen prints of exemplary displays resulting from the Baseline/Actual Schedule Analysis.

### DETAILED DESCRIPTION

Before any embodiments of the invention are explained in detail, it is to be understood that the invention is not limited in its application to the details of construction and the arrangement of components set forth in the following description or illustrated in the following figures. The invention is capable of other embodiments and of being practiced or of being carried out in various ways. The use of “including,” “comprising,” or “having” and variations thereof herein is meant to encompass the items listed thereafter and equivalents thereof as well as additional items.

As should also be apparent to one of ordinary skill in the art, the systems and arrangements shown in the figures are models of what actual systems might be like. Many of the modules, tools, and logical structures described are capable of being implemented in software executed by a microprocessor or a similar device or of being implemented in hardware using a variety of components. Terms like “system”, “platform”, “controller”, “interface”, “module”, or “tool” may include or refer to hardware and/or software.

Furthermore, the specification may include capitalized terms. Such terms are used to conform to common practices. However, no specific meaning is implied or should be inferred simply due to the use of capitalization. Thus, the claims should not be limited to the specific examples or terminology or to any specific hardware or software implementation or combination of software or hardware.

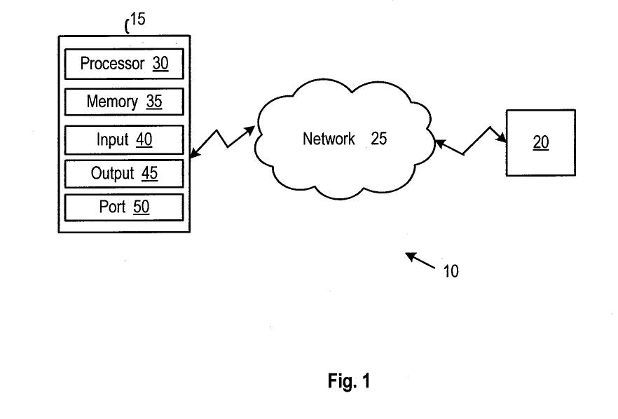

Shown in FIG. 1 of the drawings is a computer system 10 capable of supporting the invention. The computer system 10 represents a physical structure that allows a Project Management (PM) software package (discussed below) to interact with a Discrete Event Simulation (DES) software package (discussed below). The exemplary system 10 includes a first computing device 15, a second computing device 20, and a network 25 coupling the first and second computing devices 15 and 20.

The first computing device 15, in one construction, is a general-purpose personal computer (PC). Alternatively, the first computing device 15 can be a network computer terminal, a hand-held computing device, an Internet appliance, or a similar device. The first computing device 15 includes a processor 30 and a memory 35. The memory 35 includes instructions (in the form of software code, modules, programs, etc.) executable by the processor 30 to operate and control the first computing device 15. The memory 35 also includes data, which may be in the form of a data structure. As will be apparent to someone skilled in the art, based on the description herein, the first computing device 15 can include all of the necessary architecture to execute the packages, modules, interfaces, tools, etc. discussed herein and the necessary architecture to store the data and data structures discussed herein. Alternatively, one or more of the packages, modules, tools, interfaces, data, data structures, etc. can be stored and/or executed at one or more other computing devices, such as the second computing device 20, in communication with the first computing device 15. It should be understood by one skilled in the art that, when the processor executes particular instructions, the computing device 15 becomes a particular machine performing particular operations. Similarly, other computing devices (e.g., device 20) become a particular machine when performing particular instructions.

The first computing device 15 includes or is coupled to an input device 40, an output device 45, and a first communications port 50. The input device 40 (e.g., a keyboard, keypad, tracking device, touch screen) and the output device 45 (e.g., a display, printer) allow an operator of the IPT to interact with the first computing device 15. Of course, the input and output devices 40 and 45 can be combined as a single device. The first communications port 50 promotes communication with an external device such as the second computing device 20.

The second computing device 20, in one construction, is a server in communication with the first computing device 15. Alternatively, the second computing device 20 can be a general-purpose PC, a network computer terminal, a hand-held computing device, an Internet appliance, or a similar device. The second computing device 20 also includes a processor and a memory, which can be similar to the processor and memory discussed above. As will be apparent to someone skilled in the art, based on the description herein, the second computing device 20 can include some of the architecture to execute the packages, modules, interfaces, tools, etc. discussed herein and the architecture to store the data and data structures discussed herein. The second computing device 20 also includes a second communications port for promoting communication with an external device such as the first computing device.

The communications network 25 can be a distributed network having other devices not discussed herein. Example networks include the Internet, an intranet, an area network, etc. that promotes communication between the first and second computing devices 15 and 20.

For the embodiments of the invention further discussed below, it will be assumed, unless specified otherwise, that the modules, packages, tools, interfaces, data, data structures, etc. are stored and executed by the first computing device 15.

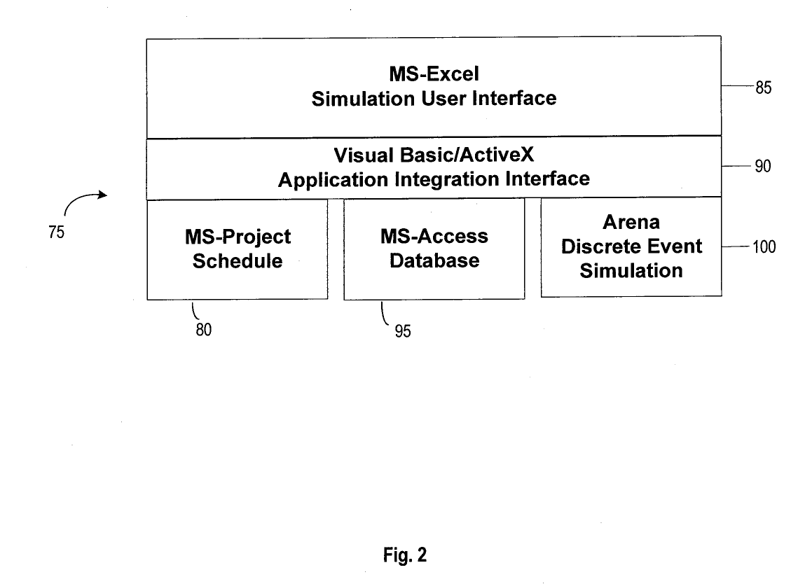

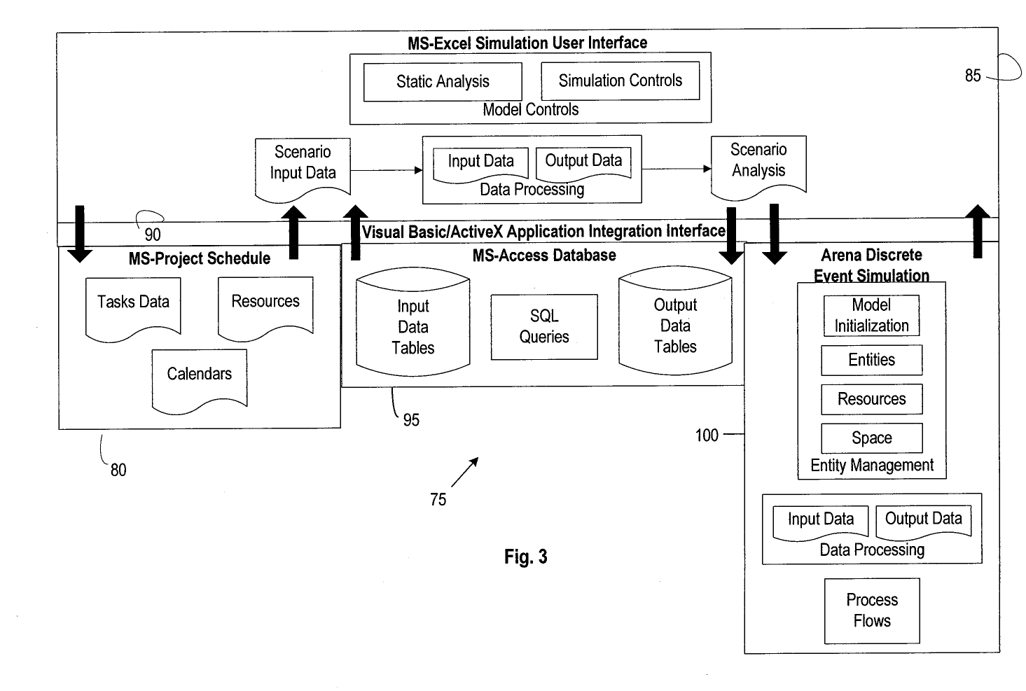

The first computing device 15 executes code represented by structure 75 of FIG. 2. The structure 75 includes five components: a Project Management (PM) software package 80, a Simulation User Interface (SUI) 85, an Application Integration Interface (AII) 90, a Database software package 95, and a Discrete Event Simulation (DES) software package 100. A more detailed, exemplary implementation of the structure 75 is shown in FIG. 3.

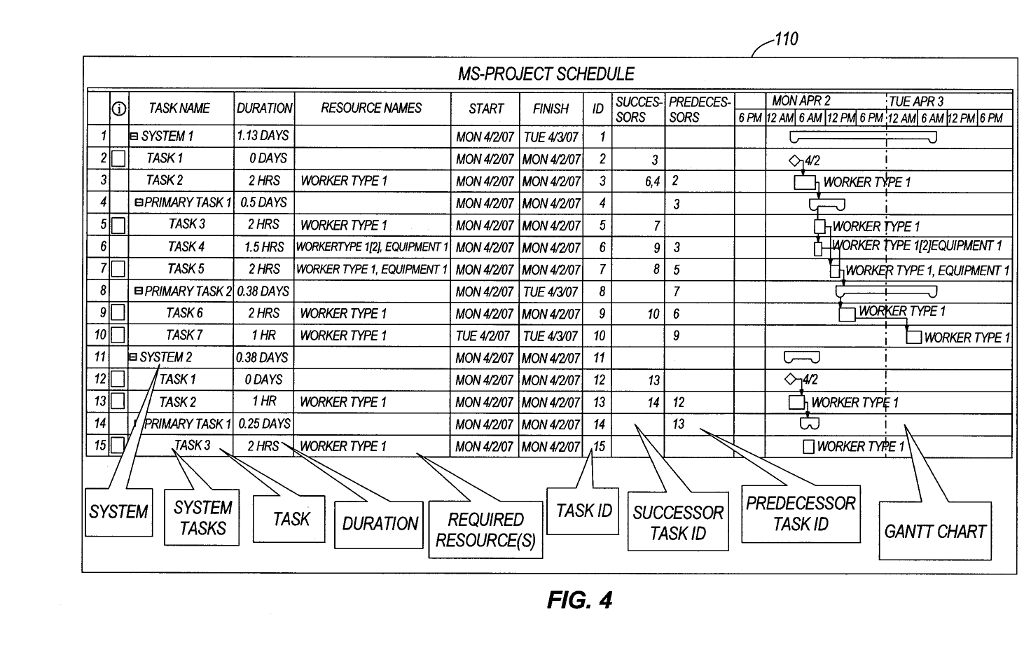

The PM package 80, which in one implementation is MS-Project® software (although others could be used) and when being executed operates as a project manager, develops plans, assigns resources to tasks, tracks progress, manages budgets, and analyzes workloads of a project. The PM package 80 can perform these operations via a process flow, which is referred to herein as a Schedule. The Schedule is defined by the IPT and manages the project or to define unique system routings and configurations. The Schedule is also a repository of project data, provided by members of the IPT. An example screen print 110 of a schedule being prepared using MS-Project® software is shown in FIG. 4. The project data can include, for example, the following types of data:
Tasks—can refer to the Table Entry View generated using the PM package 80 such as MS-Project® software
   System (Level 1)—System/Entity that has Tasks performed on it
   Primary Task (Level 2)—Grouping of Tasks
   Associate Task (Level 3)—Grouping of Tasks within the Primary Task
   Type (Level 4)—Grouping of Tasks with the Associate Task
   Task—Operation performed on the System
   Project ID—ID number associated to the Task
   Project Successor—List of Successor Project Identifiers
   Project Predecessor—List of Predecessor Project Identifiers
   Resources—List of Staffing and Headcount, System Zones, Tooling required to perform a Task
   Duration—Processing Rate required to perform a Task
   Start—Date/Time at which the Task is Started
   Finish—Date/Time at which the Task is Finished
Resources—can refer to the Resource Sheet View or similar view generated using the PM package 80, such as MS-Project® software, which lists Staffing and Headcount, System Zones, and Tooling available to the project tasks
   Group—Specifies whether the resource is Staff, a System Zone, or Tooling
   Resource Name—The specific name of the Staff, a System Zones, or Tooling
   Schedule Units—Maximum number of Headcount of Staff, a Headcount that can fit in a System Zone, or number of Tooling available
   Calendar—Specific Shift Calendar for the Resource outlining the Resource's availability through a given day
Calendar—can refer to the “Change Working Time . . . ” function within the PM package 80 such as MS-Project® software
   Calendar—Start
      Calendar—Name of the Calendar
      Day—Day of the Week
      Shift1, Shift2, Shift3—Start Time of the Shift
   Calendar—Finish
      Calendar—Name of the Calendar
      Day—Day of the Week
      Shift1, Shift2, Shift3—Finish Time of the Shift

Before proceeding further, it should be understood that each software package, module, or tool may refer to similar types of data with different names. The names or titles of the types of data used herein are exemplary for MS-Project® software. Other names are possible for different PM software packages. This also applies to the other software packages described herein, including MS-Excel®, MS-Access®, and Arena® software.

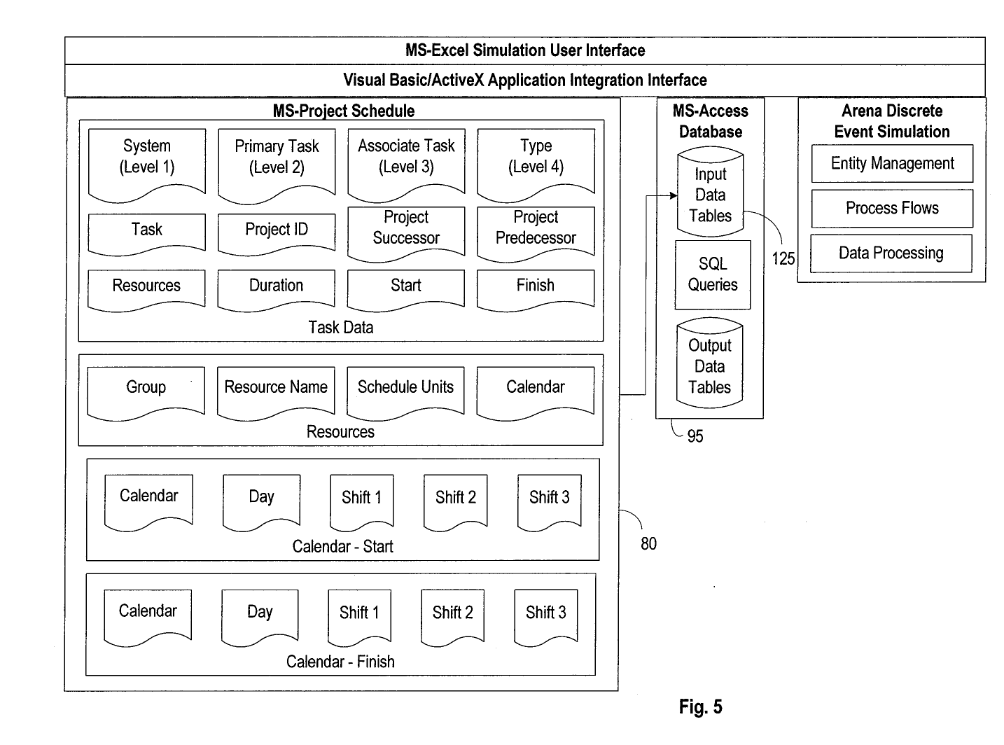

During and/or after creating the Schedule, the resulting data is communicated and transformed into Input Data Tables 125 maintained by the Database package 95 (best shown in FIG. 5). The Database package 95 in one implementation is MS Access® relational database software from Microsoft Corporation; although other relational database software packages could be used. As is discussed throughout this document, the Database package 95 provides the central repository for the Schedule Input Data, Static Analysis Output Data, and Dynamic Analysis. The Database can also include tables for Scenario Input Data and Scenario Output Data.

Referring again to FIG. 3, the Simulation User Interface 85 (SUI) can be used as a tool for controlling, processing, and communicating data among and between the PM package 80, the Database package 95, and the DES (simulator) package 100. In one implementation, the SUI 85 is enacted with MS-Excel® software. However, it is envisioned that the functions of the SUI 85 can be implemented using other software packages, including a specially designed package. The SUI 85 may provide the following functionality:
Input Scenario Data Source
Data Processing
Model Controls
Scenario Analysis

For the implementation discussed herein, the SUI 85 utilizes other tools of the Application Integration Interface (AII) 90 to accomplish some of its functionality. The AII 90 includes tools to tie together the various applications within the structure 75. In one variation, the AII 90 can be designed using Visual Basic® software from Microsoft Corporation, and ActiveX® controls. The AII 90 receives commands from the SUI 85 and then performs the necessary interfacing between packages and processing of data.

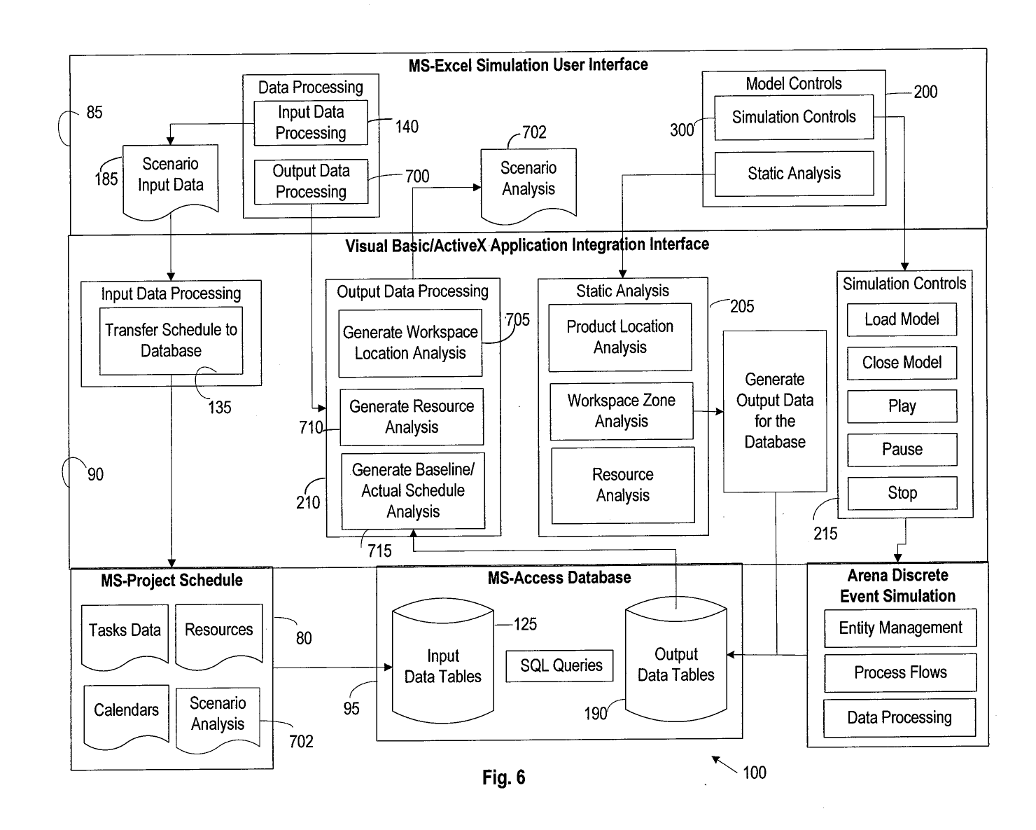

Referring now to FIG. 6, the data from the Schedule is imported into the Input Data Tables 125 with the help of a tool 135 of the AII 90. The SUI 85 includes a module referred to herein as Input Data Processing 140. Among other things, the Input Data Processing module 140 initiates the Transfer Schedule to Database tool 135. The tool 135 transfers the data of the Schedule to the Database package 95, and imports the Schedule data into the Input Data Tables 125. The imported data can then be used by the other packages and tools of the structure 75.

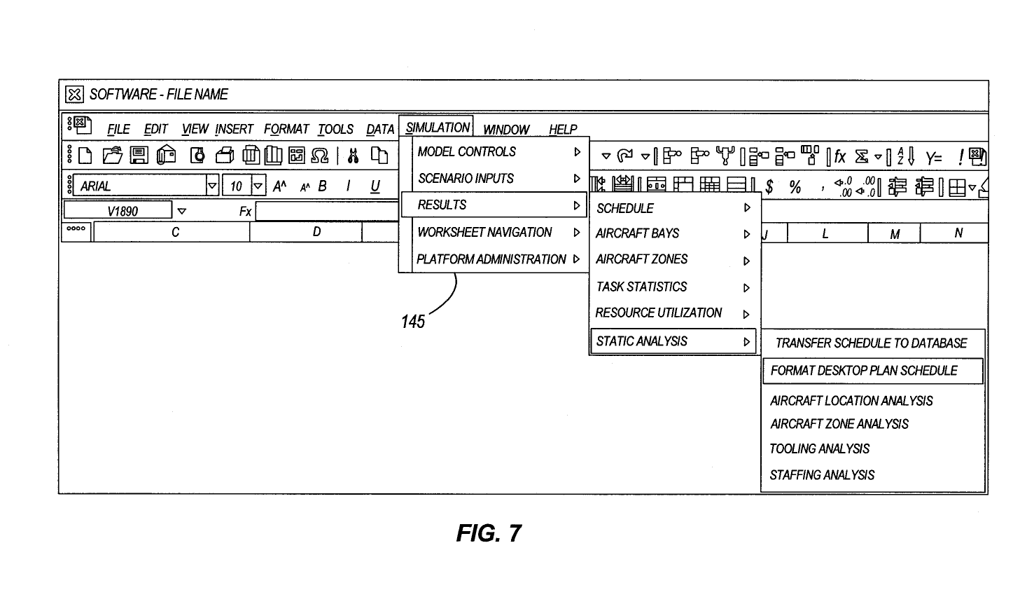

One exemplary way an operator can initiate a module and/or tool is through MS-Excel® software if MS-Excel® is the SUI package. For example and as shown in FIG. 7, MS-Excel® can include a built-in module for providing a menu structure 145. The user can then control the structure 75 (FIG. 2) through the built-in menu.

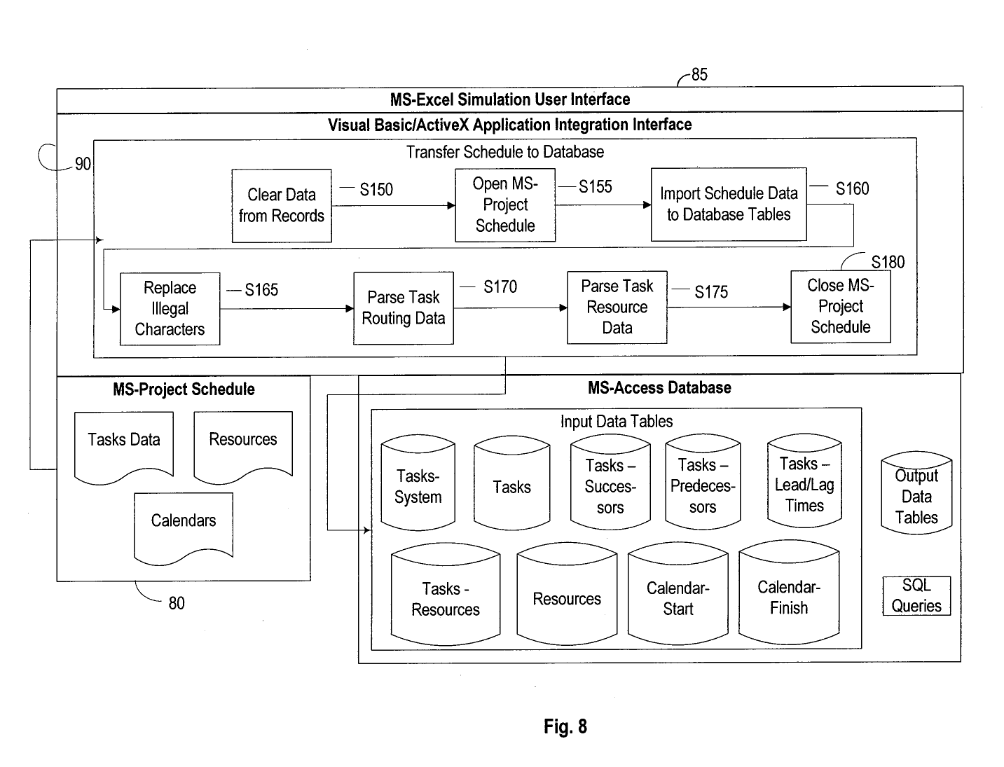

One example representation of the Transfer Schedule to Database tool 135 that imports data from the Schedule into the Input Data Tables 125 is shown in FIG. 8. The Transfer tool 135 includes instructions for clearing data from previously stored records S150, opening the Schedule S155, importing the Schedule data to the Input Data Tables S160, replacing illegal characters not recognized by the other packages S165, parsing Task Routing Data into multiple tasks S170, parsing Task Resource Data into multiple tasks S175, and closing the Schedule S180. Exemplary Input Data Tables include the following:
Tasks—System—Listing of all the Systems (Level 1 Tasks), including the following fields:
   System Name
   Project ID
   Duration
   Start
   Finish
Tasks—Listing of all the data specified on the Table Entry View generated by MS-Project® or other PM software, Including the following fields:
   System
   Primary Task
   Associate Task
   Type
   Task
   Duration
   Start
   Finish
   Resources
   Project ID
   Project Predecessor
   Project Successor
Tasks—Successors—For each Project ID (for each Task), parses the Successor Task Identifications into individual Fields “Next Task” fields
Tasks—Predecessors—For each Project ID (for each Task), parses the Predecessor Task Identifications into individual Fields “Previous Task” fields
Task—Lead/Lag Times—For each Project ID (for each Task), defines the following
   Previous Task
   Next Task
   Amount of Lead Time
   Amount of Lag Time
Tasks—Resources—For each Project ID (for each Task), parses the Resources into individual Fields “Resource” and “Assignment Unit” fields
Resources—Extraction data from the Resource Sheet View generated using MS-Project® or other PM software, including the following fields
   Group
   Resource Name
   Schedule Units
   Calendar
Calendar—Start—Extraction of data from the “Change Working Time . . . ” function from MS-Project® or other PM software, including the following fields includes the following fields:
   Calendar—Name of the Calendar
   Day—Day of the Week
   Shift1, Shift2, Shift3—Start Time of the Shift
Calendar—Finish—Extraction of data from the “Change Working Time . . . ” function from MS-Project® or other PM software, including the following fields:
   Calendar—Name of the Calendar
   Day—Day of the Week
   Shift1, Shift2, Shift3—Finish Time of the Shift

Additionally, the Input Data Processing module 140 creates and captures Scenario Input Data 185 (FIG. 6). The Scenario Input Data 185 includes data maintained in the Input Data Tables 185 and further data processed and captured by the SUI 85. For example, the PM package 80 produces data that is specific to its software. The SUI 85 can acquire the Schedule data (e.g., from the Input Data Tables 125) and further process the data for other Scenario Input Data 185 not normally supported by the PM package 80. As a specific example, the IPT may assign a duration to a task (e.g., 2.3 hours) of the Schedule. The duration is a prediction for the task. In the real world, however, the task may take anywhere between 1.5 and 3.1 hours, which is not accounted for in the PM package. The SUI 85 (e.g., MS-Excel® or other spreadsheet software) can assign a statistical feature (e.g., a distribution) to the duration that the PM package 80 cannot. As another specific example, the PM package 80 may specify a shift. With the SUI 85, the data relating to the shift can be expanded. For example, the SUI 85 can define a distribution to the number of workers for the shift (to account for sick days, for example). The resulting Scenario Input Data 185 can be exported and saved in the Input Data Tables 125, and used by other components of the System 75.

The Output Data Tables 190 (FIG. 6) maintained by the Database 95 are populated with data resulting from other processes discussed further below. The data from the Output Data Tables 190 can also be used by the other packages and tools of the structure 75.

Referring again to FIG. 6, the module referred to herein as Model Controls 200 initiates two types of analysis: Static Analysis and Dynamic Analysis. Static Analysis utilizes the Input Data Tables 125 and/or Scenario Input Data 185, a Static Analysis tool 205, an Output Data Processing tool 210, and the visual tools of MS-Excel® or MS-Project® software to analyze the relationships of systems, tasks, events, etc. of the Schedule. Dynamic Analysis utilizes the Simulation Controls tool 215, the DES package 100, the Input Data Tables 125, the Output Data Processing tool 210, and the visual tools of MS-Excel® or MS-Project® software to analyze the relationships of systems, tasks, space, resources, etc. of the Schedule and to determine the simulated outcome of the project as influence by these relationships.

The Static Analysis tool 205 can utilize similar code for each type of static analysis (i.e., product location analysis, workspace zone analysis, and resource analysis) shown in FIG. 6. The difference among the analyses is the source of the data, the fields, data used in the SQL queries, and destination for the analyses. Therefore, upon selecting a Static Analysis on a particular area of interest (such as Workspace Zone Analysis), the AII 90 first clears an appropriate Output Data Table 190 in the database, the MS-Project® Schedule, and the MS-Excel® data tables. Once this operation has completed, the AII 90 issues a series of SQL queries to populate the appropriate Output Data Tables 190 of the database. At the successful completion of population of the Output Data Tables 190, another series of SQL queries are issued to generate the analysis within the appropriate MS-Project® or other PM Analysis Schedule, and/or MS-Excel® or other SUI data tables. Exemplary Output Data Tables 190 populated by the Static Analysis can include the Output Data Tables 190 discussed below for the Dynamic Analysis. The analyses 210 that can be performed on the resulting Output Data Tables 190 can also correspond to the analyses discussed below for the Dynamic Analysis. The Static Analysis focuses on analyzing characteristics of the individual components that comprise the system. This provides the capability to eliminate issues that may complicate the results of the dynamic simulation. That is, the Static Analysis provides an opportunity for the IPT to quickly reduce the number of issues that may complicate the Dynamic Analysis.

Referring back to FIG. 6, the Simulation Control module 300 initiates the Simulation Controls tool 215. The Simulation Controls tool 215 opens, processes, and closes a model. The processing of the model includes the playing, pausing, and stopping the dynamic simulation.

The DES package 100 provides a simulation tool or simulator when executed, and provides a dynamic representation of the components of the system as defined by the Schedule and their interactions. In one implementation, the DES package 100 is the Arena® software package although, other simulation programs may be used. Upon starting the DES package 100 using the Simulation Control module 200, the DES package 100 reads the Input Data Tables 125, and initializes the model. Once initialized, Systems are created and introduced into the simulation and Tasks are executed. As the scenario executes, the simulation queries the Database Input Tables 125 for data, such as:
Task Name
Duration
Resources and Quantity of Resources
Quantity of Predecessors
Successor Task

Once the System has been routed to the appropriate Task(s), the required resources are accessed and the Task is processed for the required duration. At the start and completion of each Task, statistics are collected and records are added to the appropriate Database Output Tables 190. At the completion of the simulation, the Structure 75 generates analysis of the data within the Output Data Tables 190.

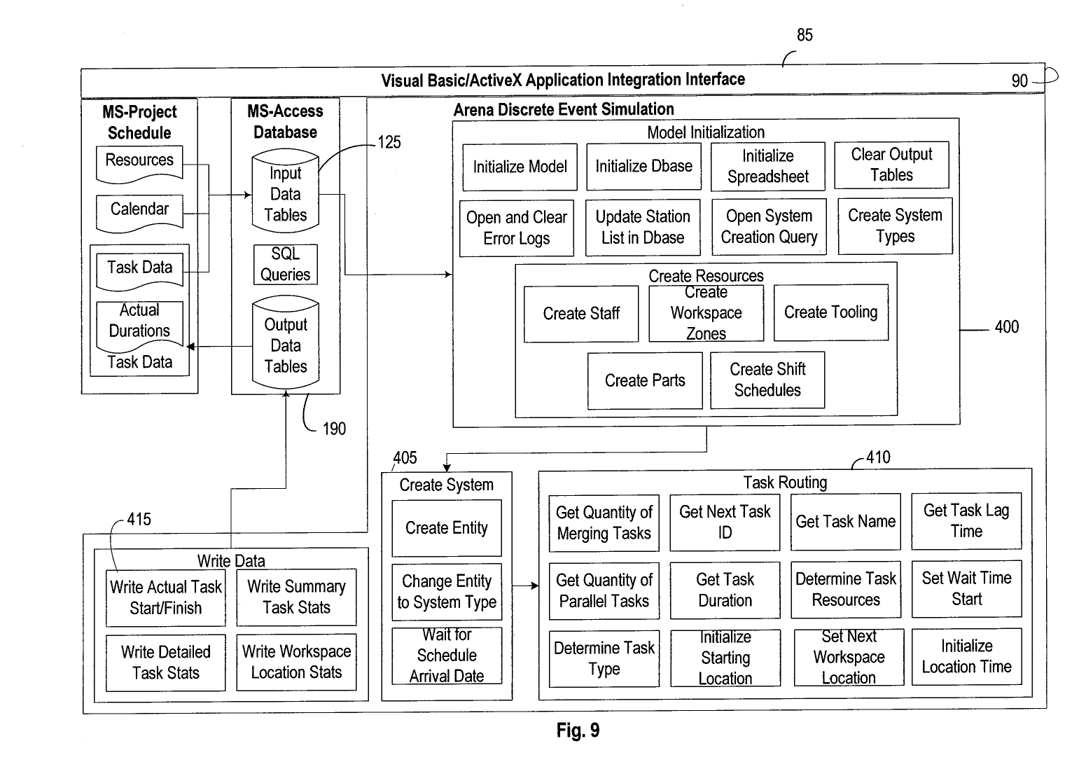

A general representation of how the DES package 100, such as the Arena® simulator, performs a simulation is shown in FIG. 9. Generally speaking, the data from the Input Data Tables 125 is accessed by a Model Initialization Module 400. For the implementation shown, the simulator program (e.g. Arena®) includes tools that allow direct communication with the relational database program (e.g. MS-Access® software). In other constructions, the communication can be through the AII 85 and/or SUI 90. The DES Package 100 performs the simulation by creating simulated Systems (referred to as Entities in the Arena® software) with the Create System module 405, and routing tasks with the Task Routing module 410. During and/or after the simulation, the DES package writes data to the Output Data Tables 190 with the Write Data module 415. Further description for the modules 400, 405, 410, and 415 is provided below.

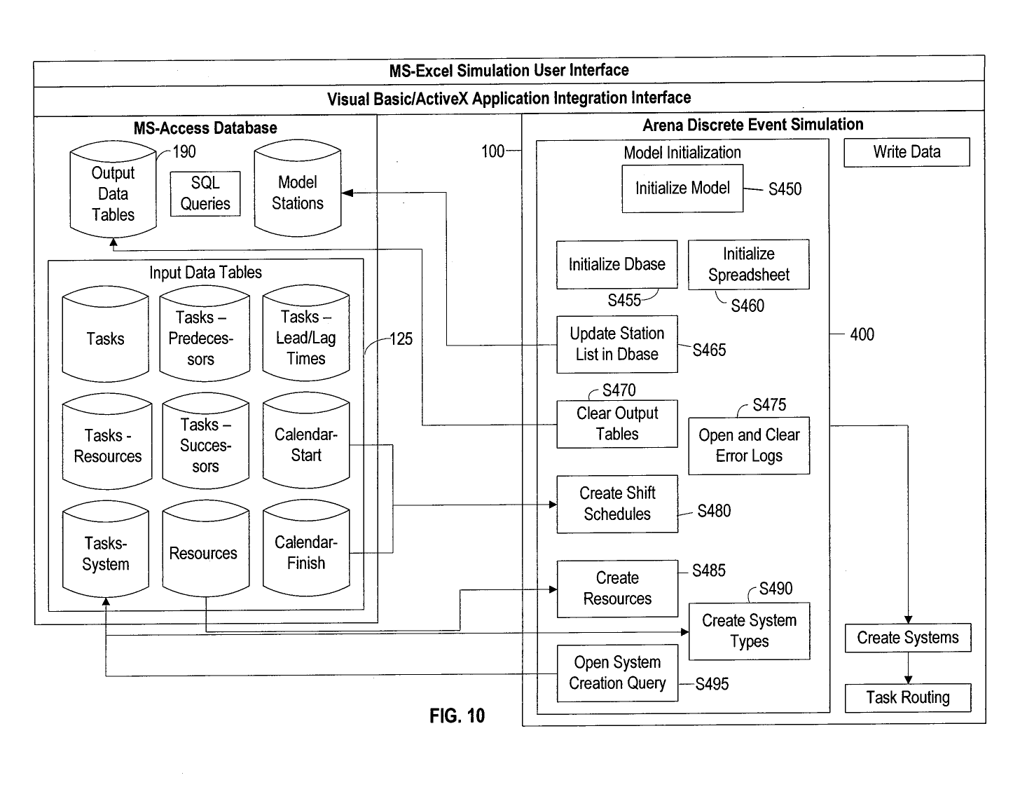

FIG. 10 represents the Model Initialization module 400 in further detail. When the DES package 100 starts, the DES package 100, which for this example implementation is the Arena® software by Rockwell, initializes a Model S450, a Database S455, and a Spreadsheet S460. The initialization S455-460 includes the creation of identifiers, parameters, pointers, directory structures, etc. for the Simulation. The DES package then updates a Station List S465 in the Database. The Station List is part of a data table called Model Stations within the Arena® DES. The Model Stations correspond to hard-coded stations of the model in the Arena® software. The DES package then clears the Output Data Table S470 and clears the Error Logs S475 for the simulation. The DES package next creates Work Shift Schedules S480 by querying the calendar information stored at the Input Data Tables 125, creates resources (staffing, tooling, system zones, shift schedules, etc.) S485 from the Resources Data Table, and creates System Types S490 that execute all the tasks of the system schedules from the Tasks-System database. Lastly, the DES package opens a System Creation Query S495. The Query queries the Task database to determine when (i.e., a start date) a System is to be entered into the Model.

Before proceeding further, it should be understood that the sequence of steps of the various methods of operation discussed herein might vary. It should also be understood that one or more steps might occur concurrently, not all steps might be required, and additional steps might by included. That is, the sequences of steps for the methods discussed herein are representative sequences.

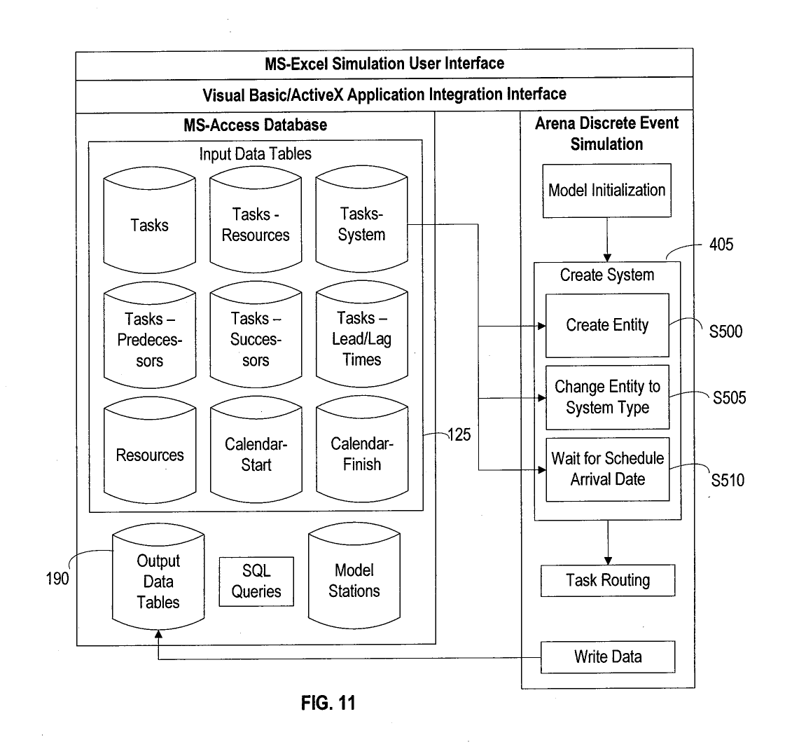

Referring again to FIG. 9, the DES package (e.g. Arena® software) creates the System after the model has been initialized. FIG. 11 represents the Create System module 405. The DES package creates the entities S500 for the simulation. The simulation works within the entity definitions of the DES package, and changes or defines the DES entities S505 to correspond to Systems stored in the Input Data Tables 125. As used herein, entities are the devices (e.g. products, loads, subsystems, components, apparatus) to be processed on or by the Arena® or other DES Software Package. The DES package then waits S510 for the Arrival Date (i.e., schedule start date) specified in the task system database table. Once the Arrival Date occurs in the simulation, the System is introduced in the Task Routing to be processed with the Tasks.

When a System is introduced, the introduction is the only time the simulation uses the system time (e.g., as compared to start or end times of a task) from the Schedule. The simulation simulates using the durations and determines the simulated end times, which may be later compared to the Schedule times. Only when a System enters does the information get relied upon. The reason for this is to be independent from the Schedule, which allows for comparison.

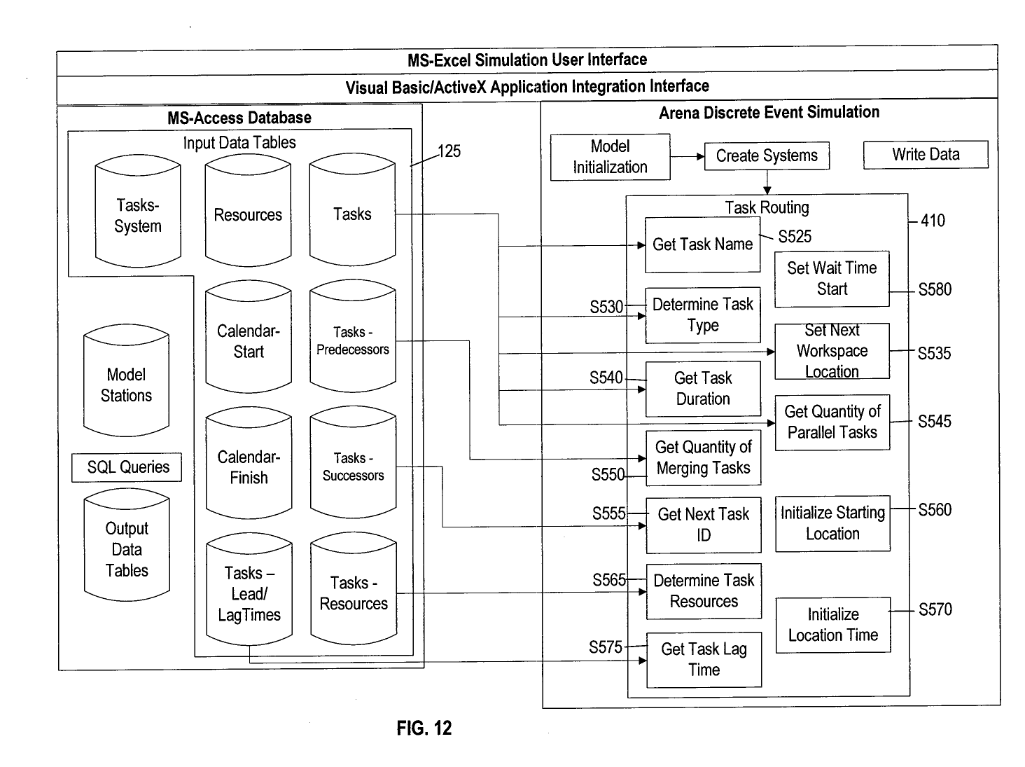

FIG. 12 represents the Task Routing Interface module 410. For this module, a system has been created and is introduced in the simulation at the specified start times. Once the System enters into the simulation, the processing of one or more tasks begin for the System. The Task Routing module 410 queries the Database to get the Task Name S525. The Task Name represents a model station (previously discussed) within the Arena® software.

The module 410 then determines the Task Type S530. The Task Type may require or result in normal processing or may require a determination for additional Resources (e.g., moving to a new Work Location or Space) not currently being used by the System. If the Task requires a new Workspace Location, then the Task Routing module sets the Next Workspace Location for the System S535.

The module 410 then gets a task Duration S540, determines whether parallel Tasks exist S545, and whether other Tasks merge with the existing task S550. The module 410 then gets the identification of the Next Task S555, initializes the starting Location of the Task S560, and determines the Resources S565 that the Task needs. The module 410 also initializes the location time S570. The task lag time S575 is the amount of time the system needs to wait to process the task. The initialization is necessary to get the output. The module also sets a Wait Time Start S580 statistic indicating when the Task is waiting to be processed.

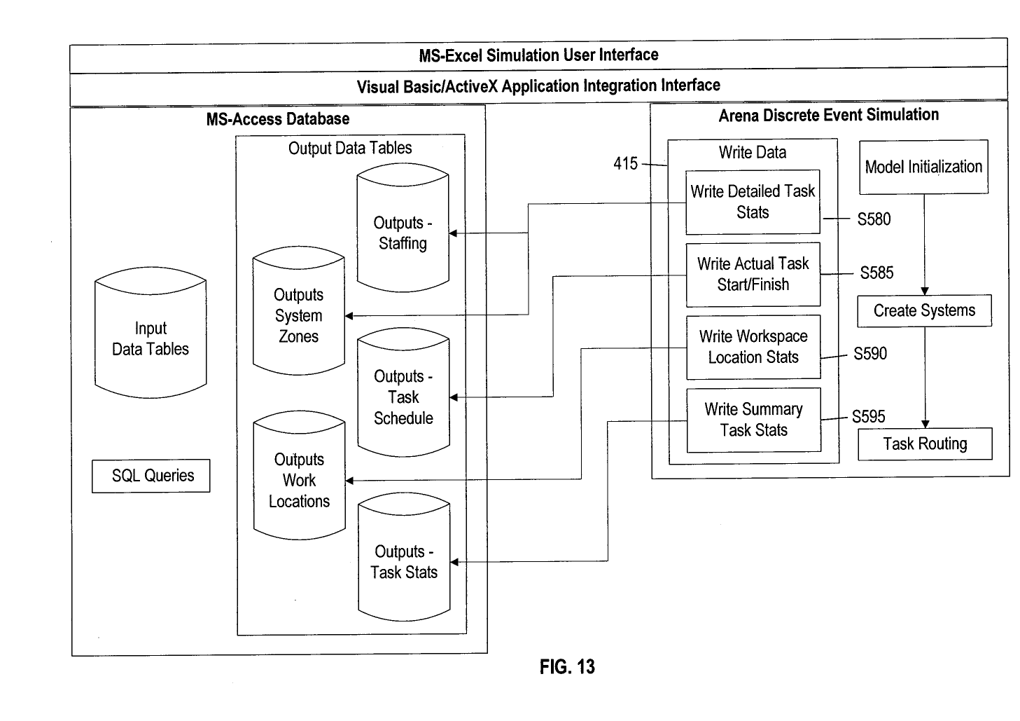

FIG. 13 represents the Write Data module 415. This module 415 writes the data to the Output Data Tables 190. As the simulation runs and completes tasks, the simulation collects the data regarding the operation of the task and writes the data to the database, including writing detailed Task statistics S580, writing actual Task Start and Task Finish times S585, writing Workspace Location statistics S590, and writing summary Task statistics S590. The types of Output Data Tables include
Outputs—Work Locations—Output data used for Work Location Analysis, including the following fields
   Location
   System
   Primary Task
   Project ID
   Type
   Start—Time Entering Location
   Finish—Time Leaving Location
   Duration—Duration at the Location
Outputs—System Zones—Output data used for System Zone Analysis, including the following fields
   Project ID
   System
   Primary Task
   Associate Task
   Task
   Zone Type
   System Zone
   Staff Quantity—Headcount occupying the Zone
   Start—Time Entering the Zone
   Finish—Time Leaving the Zone
   Duration—Duration in the Zone
Outputs—Staffing—Output data used for Staffing Analysis, including the following fields
   System
   Primary Task
   Task
   Staff
   Headcount
   Start—Time Starting to use the Staff
   Finish—Time finished using the Staff
   Duration—Duration utilizing the Staff
Outputs—Task Schedule—Output data used for Task Schedule Analysis, including the following fields
   Project ID
   Actual Start—Time the Simulation started processing the Task
   Actual Finish—Time the Simulation finished processing the Task
Outputs—Task Stats—Output data used for Task Processing Analysis, including the following fields
System
Primary Task
Task
Project ID
Total—Summation of the “Process” and all the “Wait” fields
Process—Time processing the Task
Wait Resource—Time Waiting for a Resource
Wait Schedule—Time Waiting for a Shift to Start
Wait Stage—Time Waiting for Space

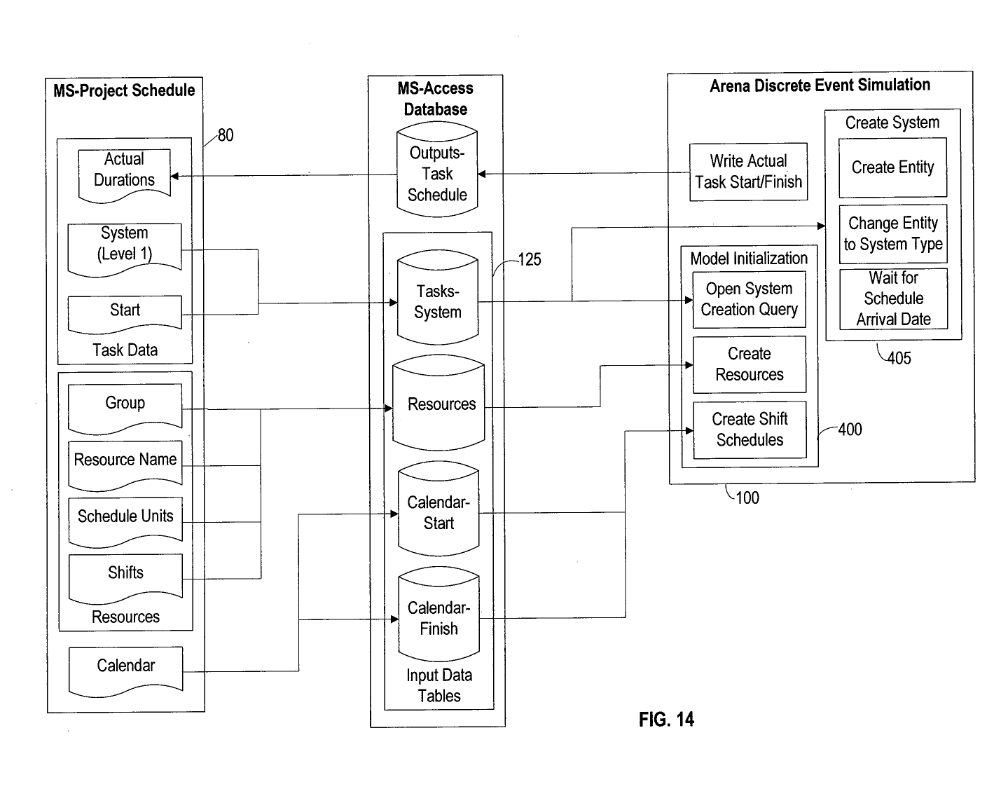

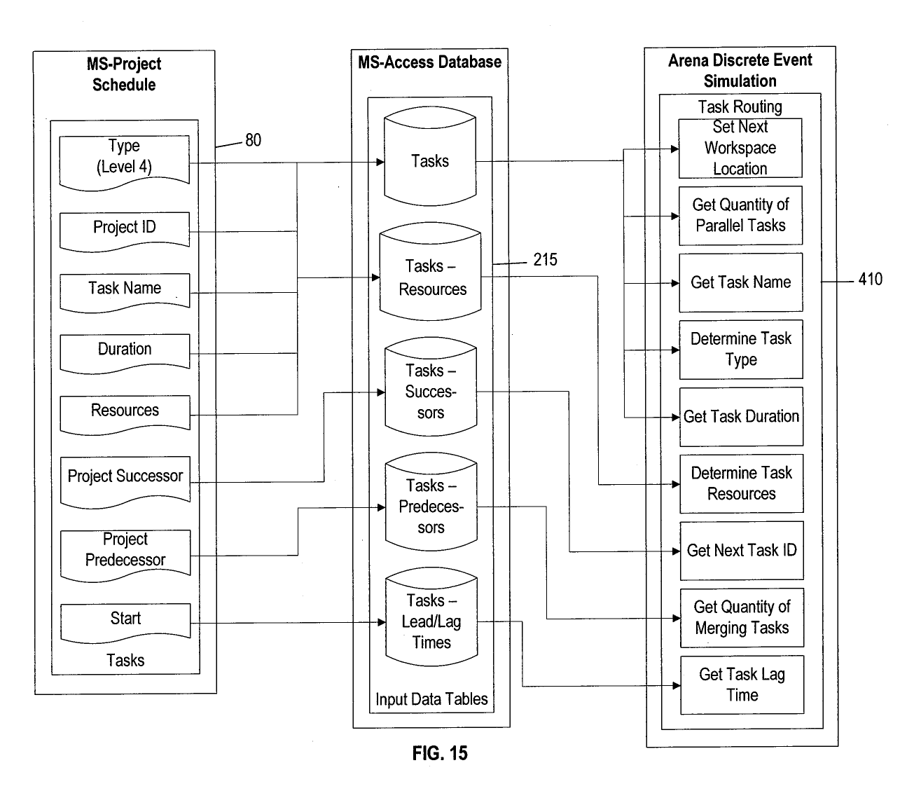

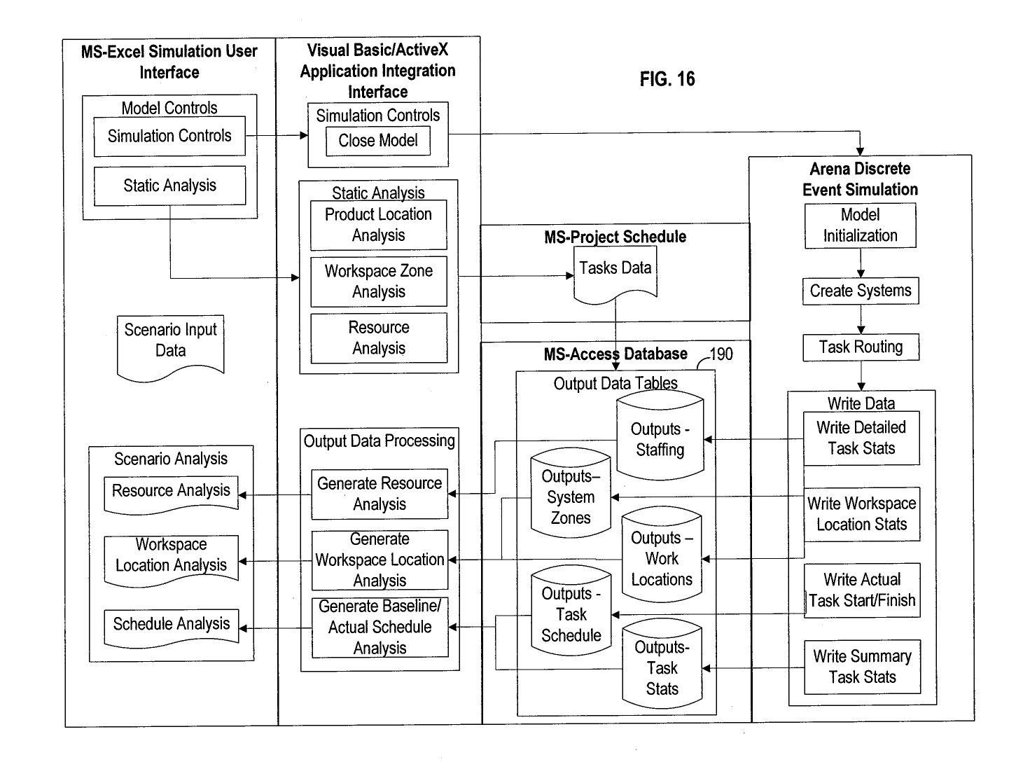

Referring now to FIG. 14, the figure provides further clarification for the flow of data from the Project Management package 80 to the Input Data Tables 125 to the Create System module 405, and the Model Initialization module 400. FIG. 15 provides further clarification for the flow of data between from the Project Management package 80 to the Input Data Tables 125 to the Task Routing module 410. FIG. 16 provides further clarification of the flow of data to populate the Output Data Tables 190. FIG. 16 also represents the flow of data from the Output Data Tables 190 to the Output Data Processing and the Scenario Analysis (discussed below).

Referring again to FIG. 6, Scenario Analysis is initiated through controls of the Output Data Processing module 700 of the SUI 85 and processed using a series of tools within the AII 90. The tools, when executed, implement a scenario analyzer. The data used for the analyses can be obtained from the Output Data Tables 190. The three types of analyses are identified herein as
Workspace Location Analysis
Resource Analysis
Baseline/Actual (i.e., Baseline/Simulated) Schedule Analysis
   The result of the Output Data Processing tool (FIG. 6) are Scenario Analyses 702 that can be viewed either in the SUI or the PM package.

The objective of the Generate Workspace Location Analysis module 705 is to identify the state of workspace allocation, and to identify allocation conflicts and resolution to those conflicts. There are three states of Workspace Allocation:
Allocated
Over Allocated
Empty

The Workspace Location Analysis includes a System Zone Analysis and a Work Location Analysis. The technique to perform a System Zone Analysis and a Work Location Analysis are very similar, and thus are identified in FIG. 6 under the Generate Workspace Location Analysis tool 705.

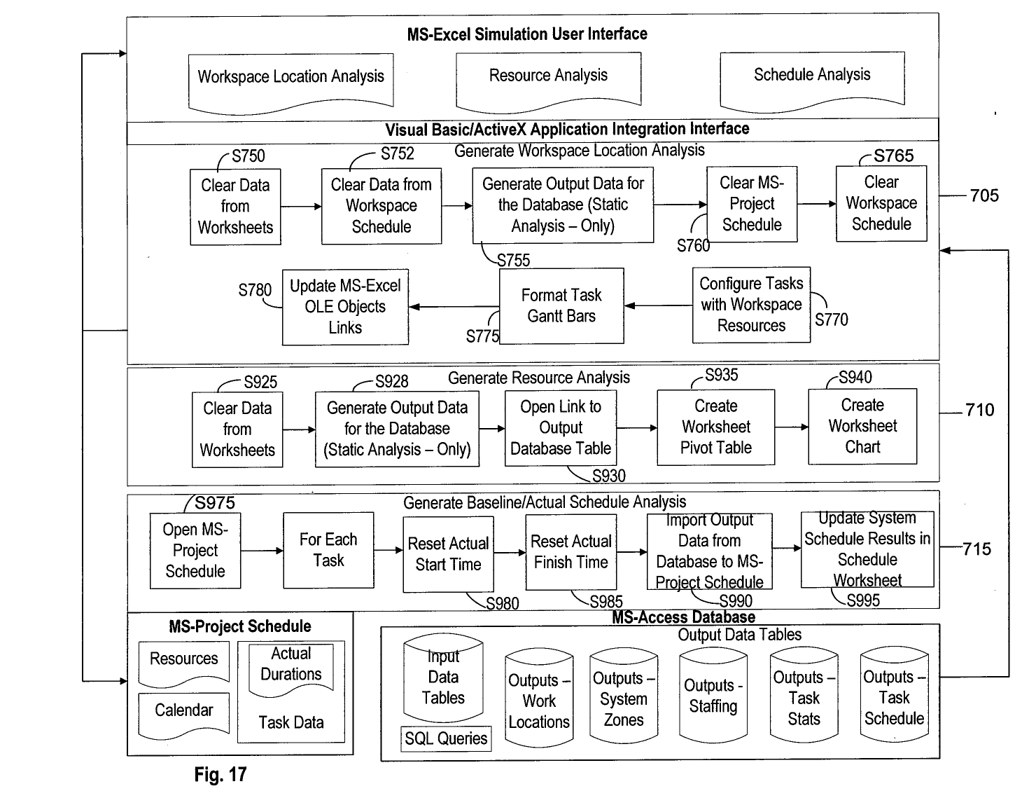

As shown in FIG. 17, one implementation of the Generate Workspace Location Analysis tool 705, which can use MS-Project® and MS-Excel® software for example, includes clearing data from prior worksheets S750, clearing data from a Workspace Schedule S752, generating Output Data for the Output Data Tables S755 (if necessary for a Static Analysis), clearing the current MS-Project schedule S760, create a Workspace Schedule S765 in MS-Project® or other PM software, configuring tasks with the Workspace Resources S770 of MS-Project®, formatting Gantt Bars S775 using MS-Project® software, and updating OLE Object Links with MS-Excel® software.

Workspace Location Analysis can be performed at the macro level, the location of an item of interest (e.g., a System) within an environment (e.g., a Facility); or at the micro level, the location on an environment. Workspace Allocation can be illustrated in increments of minutes, hours, days, or months depending on the duration of the project. Once the Workspace Allocation conflicts and resolution have been identified, updates are made to the Schedule and a new Simulation Scenario can be executed and analyzed.

Facility Workspace Analysis shows the location of a System within a Facility and Type Of Task being performed on the System. Data is written to the Output—Workspace Location data table from either the Simulation or the SUI's Static Analysis Control. Using the PM package 75, such as MS-Project® software, to perform “spatial analysis”, provides the capability to take advantage of Gantt Charts and Resource Usage Analysis features of the MS-Project® software. One advantage of MS-Project's Gantt Chart feature, is the ability to imbed a greater amount of data in a hierarchal format that can be zoomed in/out. Within the Work Location Analysis, the task bars and summary bars display the time and duration the space is occupied, and the type of task performed within that space. Consequently, “white space” (idle time) is also displayed for each Work Location on the Gantt Chart.

At the core of the Gantt Chart analysis is the implementation of “task bars rolled into summary bars”, which converts a summary bar from one long continuous bar, into a summary bar segmented into subtasks and idle time. For some implementations, the System reformats the default MS-Project® Gantt bars into a rolled-up Gantt bar format. In the MS-Project® software, the Gantt bars are typically solid from start to finish and do not show gaps, or idle time, in the Schedule. This tool expands the typical summary bar to show idle time between Tasks and to show overlaps between Tasks.

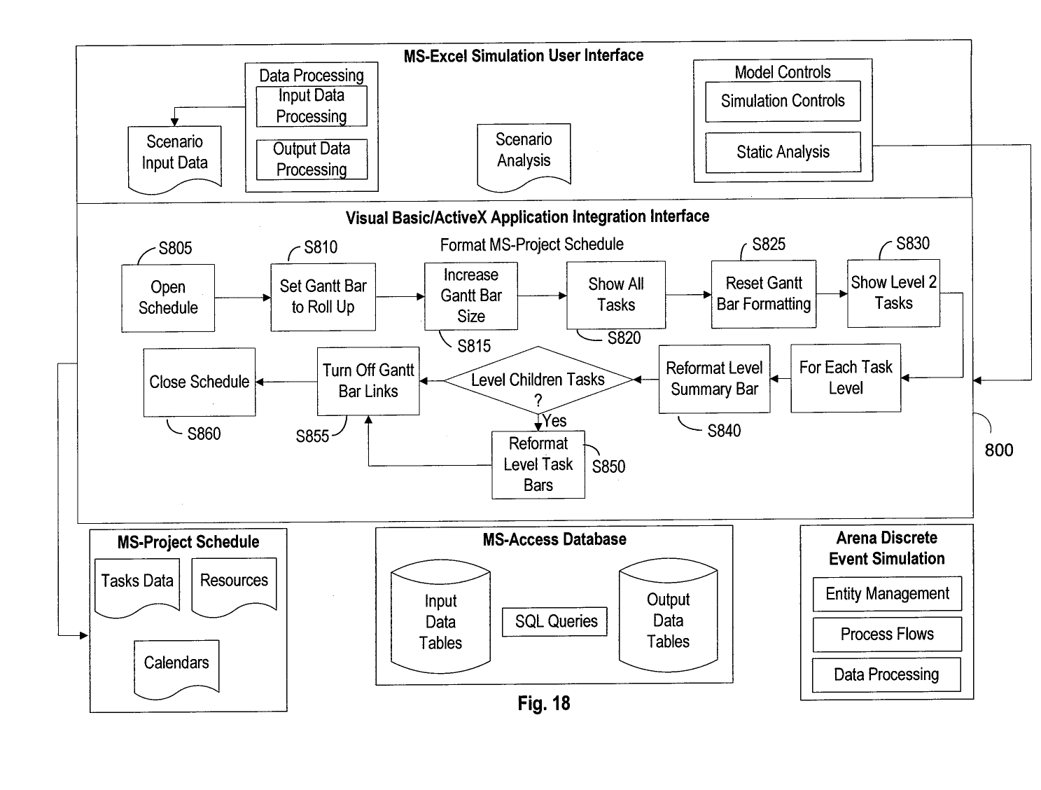

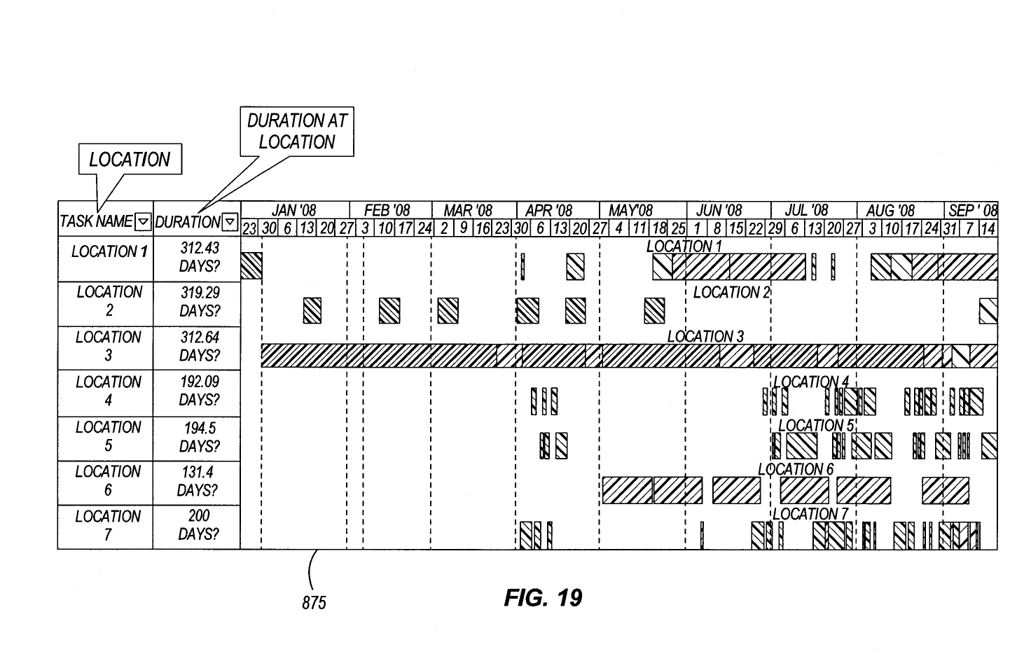

FIG. 18 represents a Format Schedule tool 800 for a rolled-up Gantt bar. The Format Schedule tool 800 utilizes the known functionalities of the PM package 75, such as MS-Project® software. When stated, the Format Schedule tool 800 opens the Schedule S805 using MS-Project® software, initializes a Gantt Bar to Roll Up S810, increases the Gantt bar size S815, shows all Tasks S820, resets the Gantt bar formatting S825, and shows the lower level tasks S830. For each level, the tool 800 reformats the Summary Bars S840 and reformats level Task Bars S845 for children Tasks. The tool 800 does the reformatting for every Summary and Task Bar. At step S855, the tool turns off the Gantt bar links and closes the schedule S860. An example screen print of a reformatted Gantt bar is shown in FIG. 19 (discussed below).

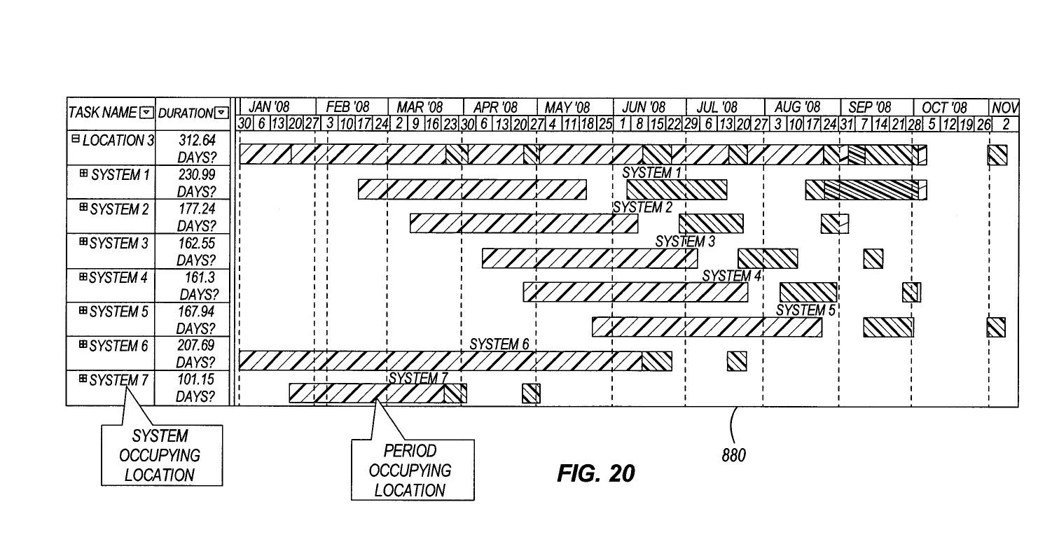

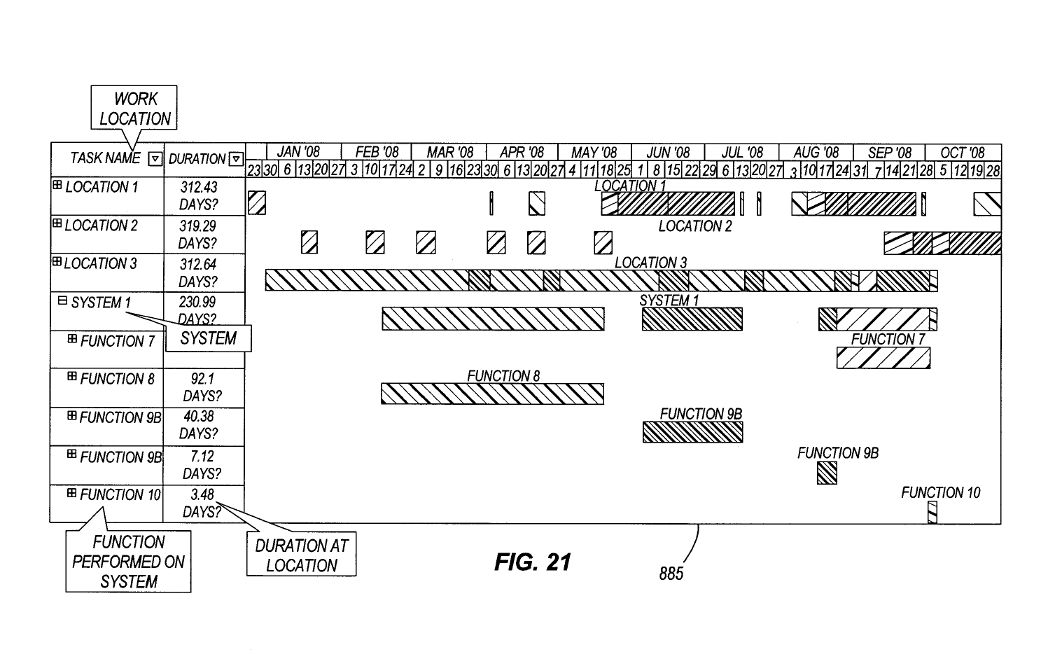

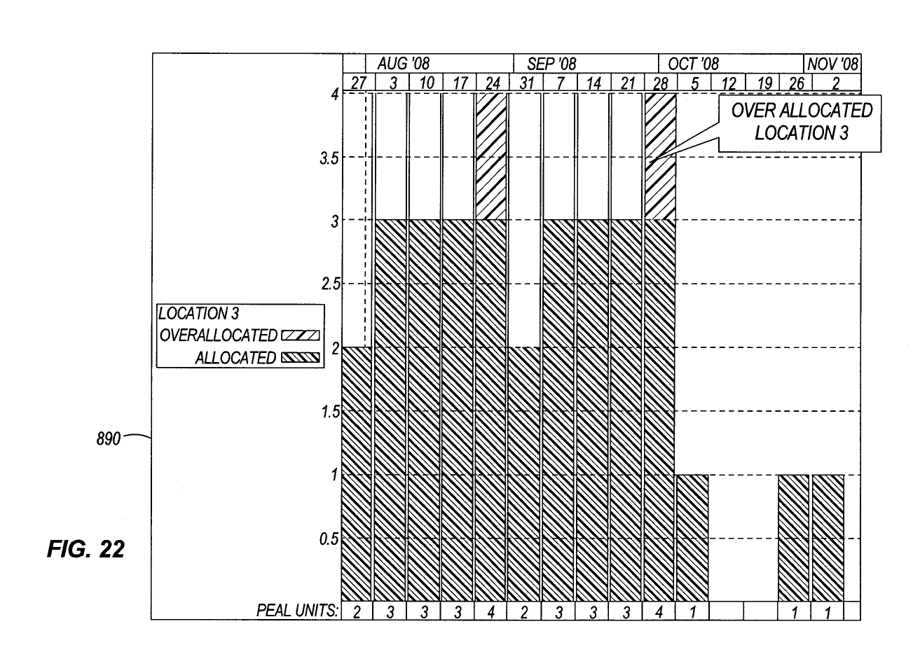

The Resource Usage Analysis or similar feature within the MS-Project® or other PM software provides the capability to quantify a Work Location's level of allocation, amount of usage, and available white space using the Resource Graph, and Resource Usage Table. To utilize the Resource Usage Analysis feature, each Work Location that is being occupied by a System, is classified as a “resource”. The Resource Units for Work Location is the System utilizing the Location. The Max Units for each Work Location is number of Work Location of a particular type. The following figures are example screen prints of the Work Location Analysis. FIG. 19 is a screen print 875 of a Gantt chart representing workspace summarization for a facility workspace analysis using MS-Project® or other PM software. The screen 875 shows a view of work locations, including Start/Finish Dates of occupation and duration of occupation, and can be color coded for each Function/Primary Task. FIG. 20 is a screen print 880 of a Gantt chart representing Work Location 3 occupied by each System of a facility workspace analysis. The screen 880 shows which system is occupying Work Location 3, shows Start/Finish Dates of occupation and duration of occupation, and can be color coded for each Function/Primary Task. FIG. 21 is a screen print 885 of a Gantt chart of System 1 at Location 3 and Task Functions performed at the Work Location resulting from a Facility Workspace Analysis, including Start/Finish Dates of occupation and Duration of occupation. The screen 885 can be color coded for each Function/Primary Task. FIG. 22 is a screen print 890 of a graph view of a Resource Utilization of Location 3 resulting from a Facility Workspace Analysis. The screen 890 can be color coded to better indicate the “Over allocation” of the Work Location.

System Workspace Analysis shows the location on the system that processing is being performed (also known as System Zone Analysis). This analysis is similar to the Work Location Analysis since it utilizes the PM software (e.g. MS-Project® software) to perform “spatial analysis”. The Resource Usage Analysis or similar feature within the PM software provides the capability to quantify a System Zone's level of allocation, amount of usage, and available white space using the Resource Graph, and Resource Usage Table.

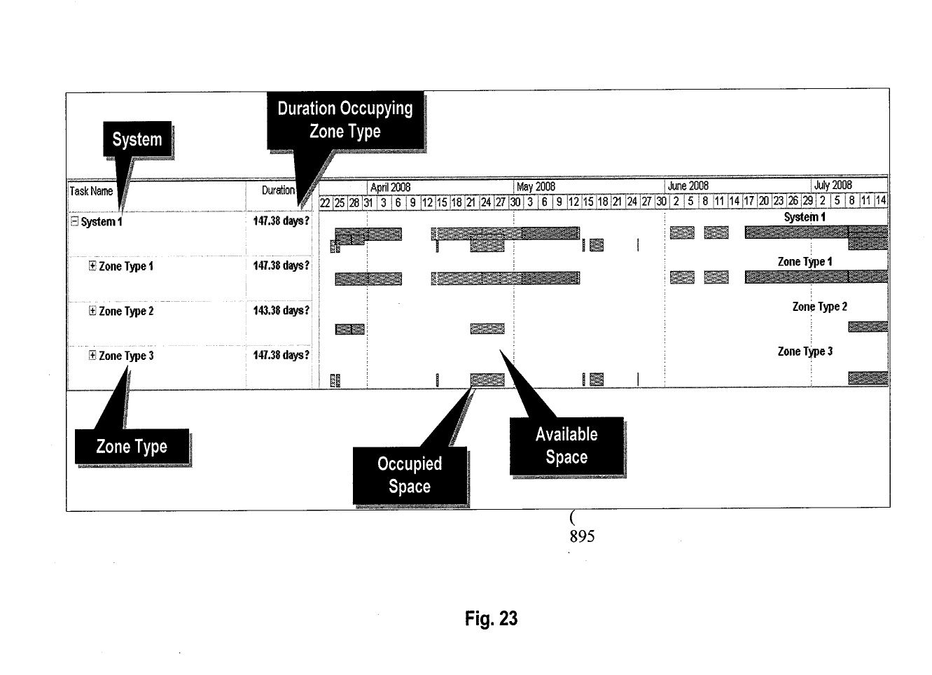

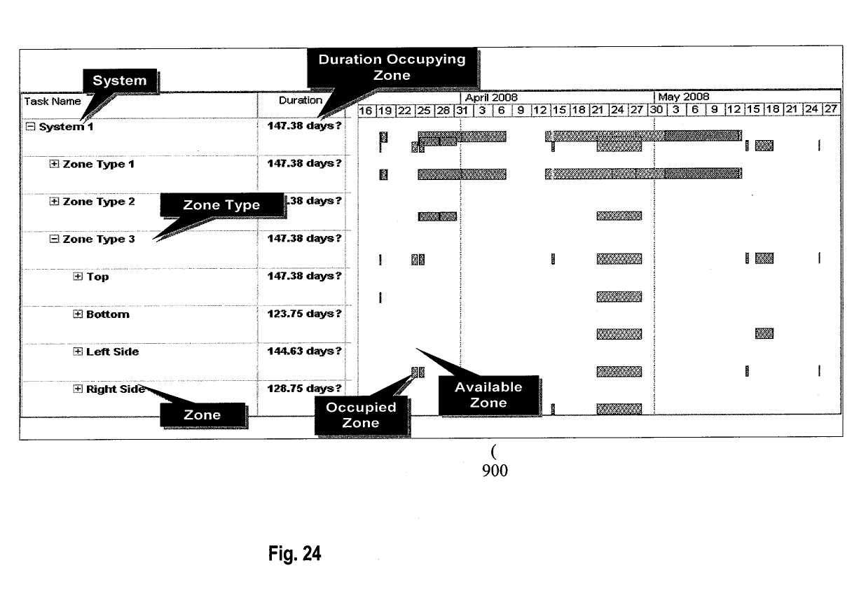

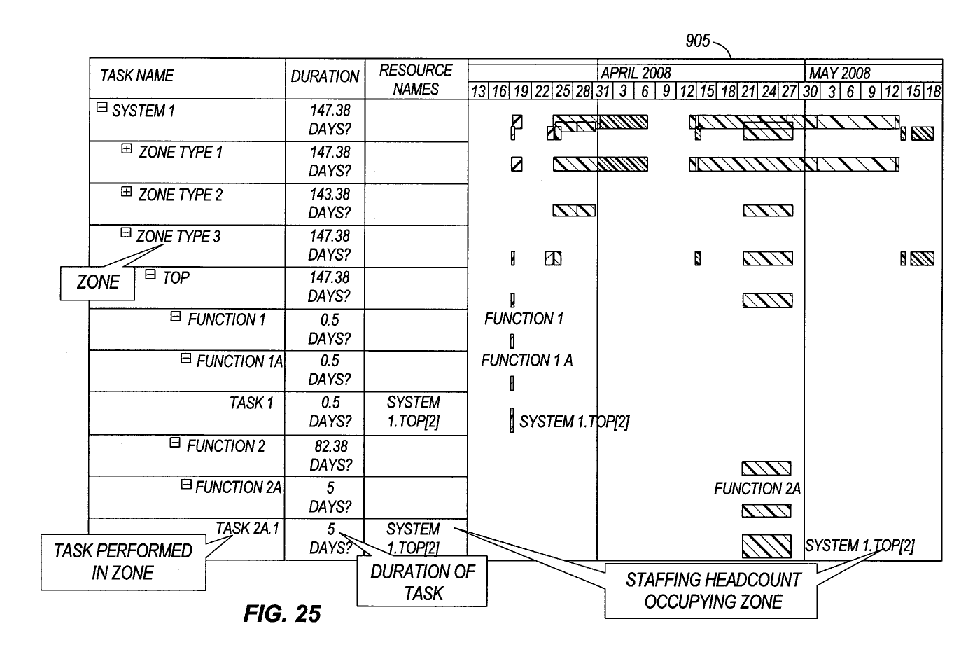

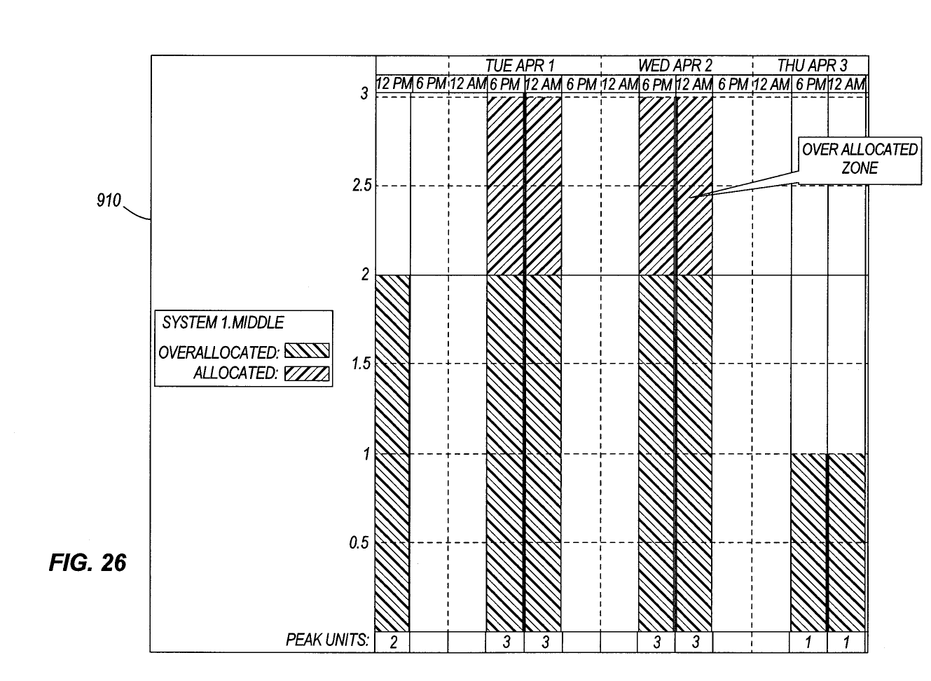

To utilize the Resource Usage Analysis feature, each System Zone for a particular system is classified as a “resource” within the PM software. The Resource Units for a System Zone is the total quantity of staff utilizing the System Zone for a particular task. The Max Units (total capacity) for each System Zone on each System is the maximum number of staff that can fit within the System. The following figures are example screen prints of the System Zone Analysis. FIG. 23 is a screen print 895 of a Gantt chart of a Zone Type Utilization for System 1 resulting from a System Workspace Analysis, including Start/Finish Dates of occupation and Duration of occupation. Screen print 890 can be color coded for each Function/Primary Task. FIG. 24 is a screen print 900 of a Gantt chart of a utilization of each Zone in Zone Type 3 for System 1 resulting from a System Workspace Analysis, including Start/Finish Dates of occupation and Duration of occupation. Screen 900 can be color-coded for each Function/Primary Task. FIG. 25 is a screen print 905 of a Gantt chart of Tasks Performed in each Zone of Zone Type 3 for System 1 resulting from a System Workspace Analysis, including Start/Finish Dates of occupation and Duration of occupation. Screen 905 can be color-coded for each Function/Primary Task. FIG. 26 is a screen print 910 of a graph view of a Resource Utilization of System 1's Middle Zone resulting from a System Workspace Analysis. The screen 910 can be color coded to better indicate the “Over allocation” of the Work Location.

Referring back to FIG. 17, the Generate Resource Analysis tool 710 provides analysis for Staffing and Tooling/Equipment. The Generate Resource Analysis tool 710 includes staffing location analysis and tooling analysis. The technique to perform a staffing location analysis and a tooling analysis are very similar, and thus are generically identified in FIG. 17 under the Generate Resource Analysis tool 710.

As shown in FIG. 17, one implementation of the Generate Resource Analysis Tool 710, which can use MS-Project® and MS-Excel® software for example, includes clearing data from worksheets S925 using the spreadsheet program (e.g. MS-Excel®), generating Output Data for the Output Data Tables S755 (if necessary for a Static Analysis), opening a link to the Output Database Tables S930, creating a worksheet pivot table S935, and creating a worksheet chart S940. The source of the data used to generate this analysis is from the database table “Outputs—Staffing”. The analysis is displayed on a series of worksheets in a summarization chart form and table form. The Resource Summarization Chart provides a high-level understanding of the resource requirements. The Resource Allocation Table provides the detailed data source for the Resource Summarization Chart. Depending on the duration of the project, Resource Allocation is illustrated in increments of minutes, hours, days, or months.

The Staffing Analysis generates two types of charts that provide a high level overview of the Staffing Distribution, and two types of tables that provide a detailed perspective of the Staffing Distribution. Both the charts and tables provide the following analysis:
Headcount per Primary Task
Headcount per Staffing Type
Peak Headcount
Average Headcount

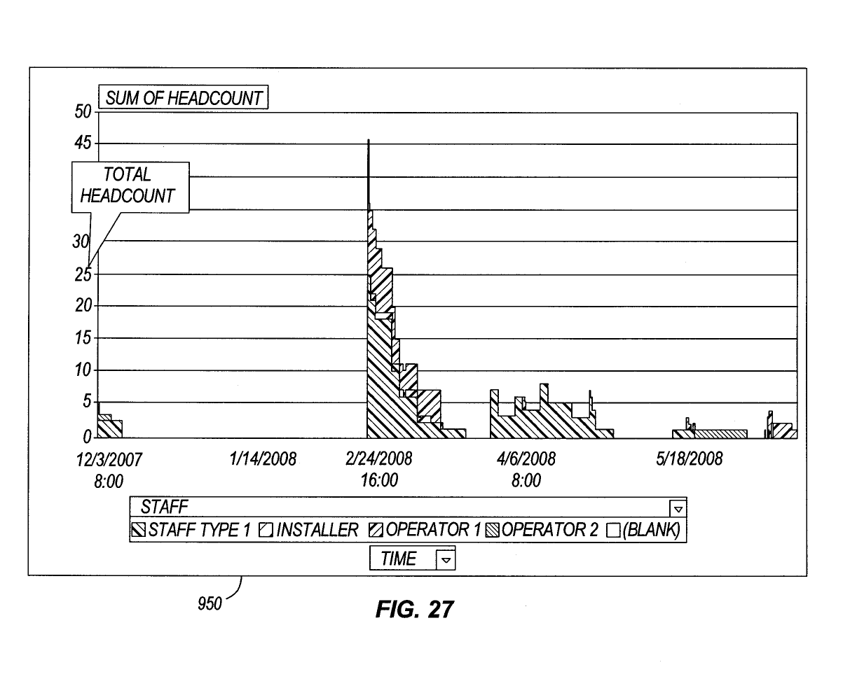

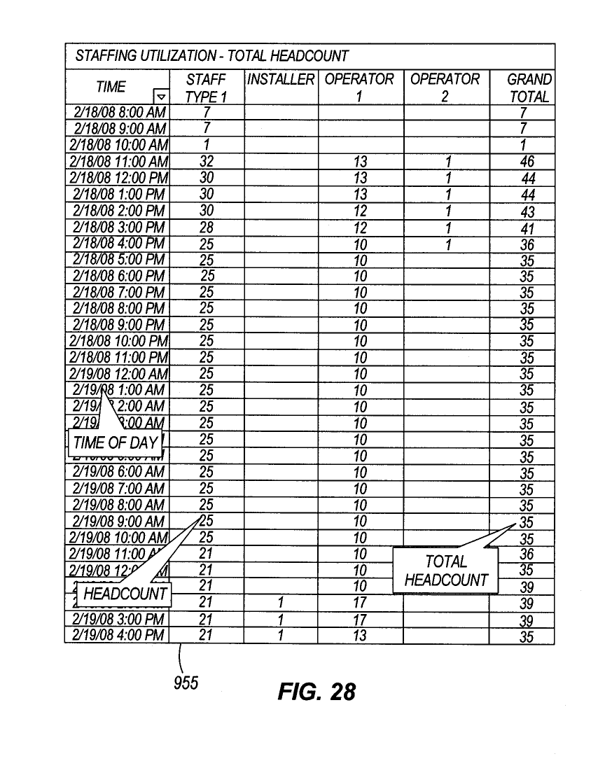

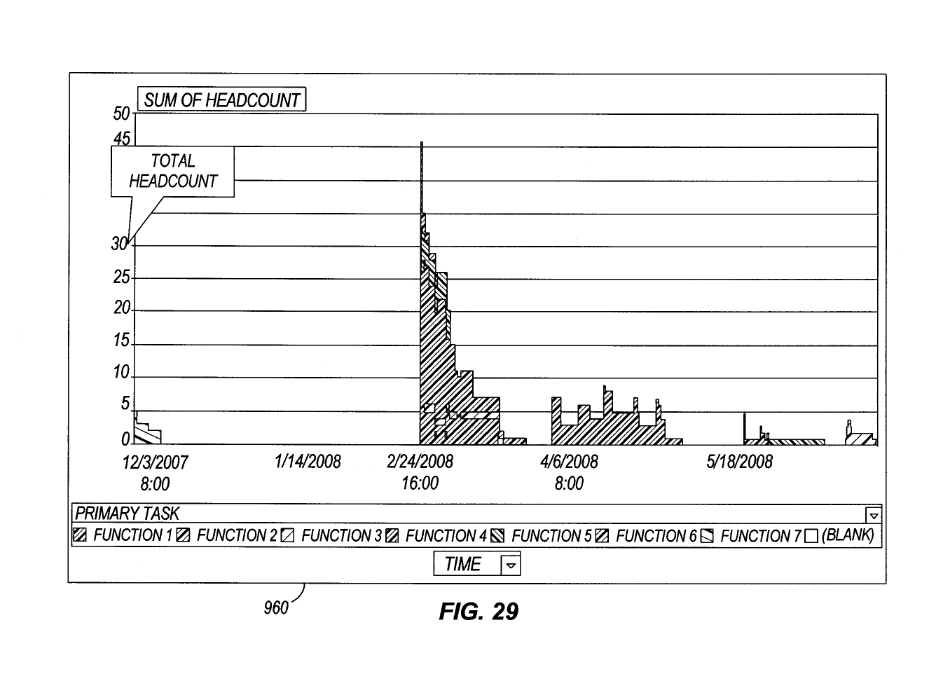

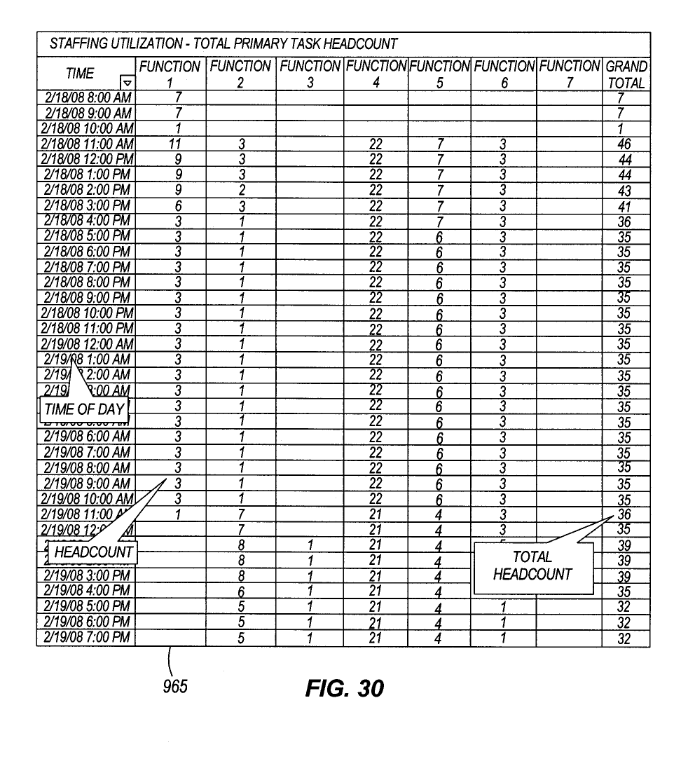

The following figures are example screen prints of the Staffing Analysis. FIG. 27 is a screen print 950 of a chart representing a Resource/Staffing Analysis of a Total Headcount by Staffing Type. The screen 950 shows the distribution of Staffing Types, and the Headcount during the Period of Performance. FIG. 28 is a screen print 955 of a table representing a Resource/Staffing Analysis of a Total Headcount by Staffing Type. FIG. 29 is a screen print 960 of a chart representing a Resource/Staffing Analysis of a Headcount by Primary Task. FIG. 30 is a screen print 965 of a table representing a Resource/Staffing Analysis Table of a Headcount by Primary Task.

Referring again to FIG. 17, the Generate Baseline/Actual Schedule Analysis tool 715 compares at least a portion of an entered Schedule to a Schedule created from the Output Data Tables 190 of the discrete event simulation. The Generate Baseline/Actual Schedule Analysis tool 715 opens an MS-Project® Schedule S975. Then, for each task, the tool 715 resets the actual start time S980, resets the actual finish time S985, imports output data from the Database to MS-Project Schedule S990, and Updates Schedule results in the Schedule Worksheet S995.

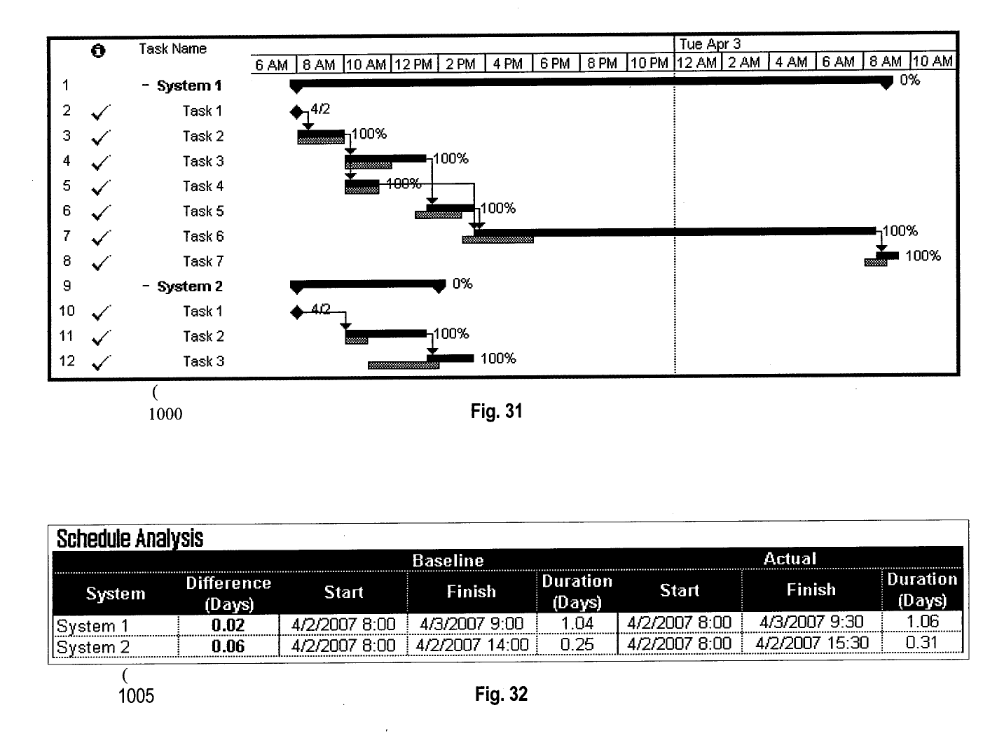

The results of a Schedule Analysis are either displayed in table form in MS-Excel software or through a Schedule in MS-Project® software, and reflect how the processing was finally accomplished. Unlike typical Project Management Analysis using the PM software, for example, the “Actual” Start and “Actual” Finish data for each task is generated by the Simulation. Therefore, the Generate Baseline/Actual Schedule Analysis is only performed after the Dynamic Analysis feature. An exemplary screen print 1000 of a Gantt chart representing a baseline/actual comparison is shown in FIG. 31. FIG. 32 is a screen print 1005 of a table comparing durations for multiple systems.

Task Analysis provides a breakdown of the Total Time required to process a task, known as Actual Duration. The Actual Duration is comprised of:
Processing Time—Time spent processing the Task
Wait Time—Time waiting for one of the following:
   Schedule
   Resource
   Workspace

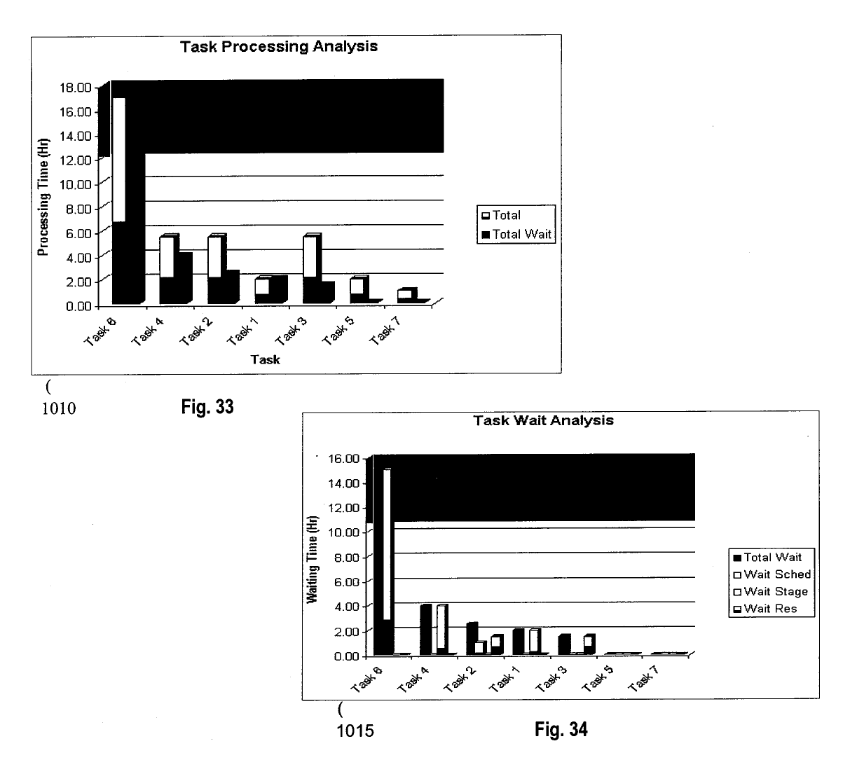

FIG. 33 is a screen print 1010 of a graph representing a Task Processing Analysis, which provides the time processing and waiting for the Task. FIG. 34 is a graph representing a Task Wait Analysis, which provides the time waiting to process the task. This includes the Total Waiting Time, the Time waiting for a Shift to Start, the Time waiting for a Resource, the Time waiting for a Workspace.

Thus, the invention provides, among other things, a new and useful platform for a project team to analyze a project entered via project management team and simulated with a discrete event simulation software package. Accordingly, the platform increases the fidelity of the analysis of the project defined within a project management software package.

What is claimed is:

1. A tool configured to perform project management analysis of a project with a computing device, the tool comprising:
a project manager implemented at least in part by the computing device to receive a schedule having project data, the project data including task data, resource data, and calendar-related data;
a discrete event simulator implemented at least in part by the computing device to create a model of the project using the project data, perform a simulation on the model influenced with the task data, the resource data, and the calendar-related data, and generate simulation data based on the simulation;
a database to store data from the project manager and the discrete event simulator; and
an interface implemented at least in part by the computing device to promote interaction among the project manager, the discrete event simulator, and the database.

2. The tool of claim 1, wherein the interface is further configured to extract the task data, the resource data, and the calendar-related data from the schedule and store the extracted task data, the extracted resource data, and the extracted calendar-related data in the database.

3. The tool of claim 1, wherein the task data includes a plurality of tasks, a respective duration related to each task and a respective successor related to each task.

4. The tool of claim 3, wherein the task data further includes a respective start time related to each task and a respective project predecessor related to each task.

5. The tool of claim 1, wherein the task data includes a task and a system having a relation to the task, the task to be performed on the system.

6. The tool of claim 1, wherein the resource data includes a plurality of resources available for the task data.

7. The tool of claim 6, wherein the resource data includes a respective schedule unit having a relation to each resource.

8. The tool of claim 1, wherein the calendar-related data includes a plurality of shifts available for the task data.

9. The tool of claim 1, wherein the task data includes a plurality of systems, a respective task performed on each system, and a resource available to the plurality of systems, and wherein the discrete event simulator is further configured to perform the simulation by simulating relationships among the plurality of systems, the respective tasks performed on each system, the resource available to the plurality of systems, and the calendar-related data.

10. The tool of claim 1, wherein the computing device is configured to execute a non-specially designed project management software package to implement the project manager and is configured to execute a non-specially designed discrete-event simulation software package to implement the discrete-event simulator.

11. The tool of claim 1, wherein the simulation data includes at least one of simulated staffing data, simulated work location data, and simulated schedule data.

12. The tool of claim 1, wherein the simulation data includes simulated staffing data, simulated work location data, and simulated schedule data.

13. The tool of claim 12, wherein the simulation data further includes simulated zone data, and simulated task statistics.

14. The tool of claim 1, and further comprising a scenario analyzer configured to perform at least one of a workspace location analysis, a resource analysis, and a baseline/simulated schedule analysis using the project data and the simulation data.

15. The tool of claim 14, wherein the interface includes the scenario analyzer.

16. A method of analyzing a project with a computing system, the computing system including a computing device, a project manager, a discrete event simulator, a database, a scenario analyzer, and an interface, the method comprising:
receiving a schedule via the computing device into the project manager, the schedule including project data;
extracting task data, resource data, and calendar-related data from the project data using the interface;
storing at least a portion of the project data, including the extracted task data, the extracted resource data, and the extracted calendar-related data, in the database;
receiving at least a portion of the extracted task data, the extracted resource data, and the extracted calendar-related data at the discrete event simulator;
creating a model with the discrete event simulator using at least a portion of the stored project data;
simulating, with the discrete event simulator, the project using the model influenced by the received task data, the received resource data, and the received calendar-related data, the simulation resulting in simulation data;
storing at least a portion of the simulation data in the database;
generating a scenario analysis with at least a portion of the stored simulation data; and
displaying at least an aspect of the scenario analysis using the computing device.

17. The method of claim 16, wherein the extracting further includes extracting system data having a relation to the task data, wherein the simulating includes applying the task data, resource data, and the calendar-related data to the system data.

18. The method of claim 16, wherein the task data includes a system, a task to be performed on the system, and a duration to perform the task, wherein the resource data includes a resource available for the task, and wherein the simulating includes simulating the task on the system, for a duration, with the resource, to generate at least a portion of the simulation data.

19. The method of claim 16, wherein the stored simulation data includes simulated staffing data, and wherein the generating the scenario analysis includes generating a staffing analysis based on the simulated staffing data.

20. The method of claim 16, wherein the stored simulation data includes simulated zone data, and wherein the generating the scenario analysis includes generating a system zone analysis based on the simulated zone data.

21. The method of claim 16, wherein the stored simulation data includes work location data, and wherein the generating the scenario analysis includes generating a work location analysis based on the system zone data.

22. The method of claim 16, wherein the stored simulation data includes simulated schedule data, and wherein the generating the scenario analysis includes generating a baseline-simulated schedule analysis based on the project data and the simulated schedule data.

23. The method of claim 16, wherein the stored simulation data includes simulated task statistical data, and wherein the generating the scenario analysis is based on the simulated task statistical data.
